(19) United States
(12) Patent Application Publication
(10) Pub. No.: US 2026/0359968 A1
(43) Pub. Date: Nov. 12, 2026

(54) METHOD AND SYSTEM FOR RECONSTRUCTING IMAGES AFFECTED BY DEFECTIVE PIXELS FOR QUALITY INSPECTION OF AN OBJECT COMPRISING INTEGRATED CIRCUIT PATTERNS

(71) Applicant: Carl Zeiss SMT GmbH, Oberkochen (DE)

(72) Inventors: Nicolas Wink, Heidelberg (DE); Martin van Driel, Muenchen (DE); Niklas Georg, Haiger (DE)

(21) Appl. No.: 19/665,139

(22) Filed: May 1, 2026

(30) Foreign Application Priority Data
May 10, 2025 (DE) 102025118014.8

(51) Int. Cl. G06T 7/00; G06T 5/50; G06T 5/60; G06T 5/77; G06T 7/73

(52) U.S. Cl. CPC G06T 7/001; G06T 5/50; G06T 5/60; G06T 5/77; G06T 7/74; G06T 2207/20081; G06T 2207/20084; G06T 2207/20212; G06T 2207/30148; G06T 2207/30168

(57) ABSTRACT

The invention relates to a computer-implemented method and optical system for quality inspection of an object comprising integrated circuit patterns using an optical system, the optical system comprising at least one image sensor having one or more defective pixels, the method comprising: providing one or more images of the object acquired by the optical system, wherein at least one of the images comprises effects of the one or more defective pixels; reconstructing pixel values in at least one of the images at locations affected by the defective pixels using a reconstruction method, wherein one or more parameters of the reconstruction method are selected based on at least one parameter of the optical system used to acquire the one or more images; and detecting one or more defects in the object and/or determining positions of structures in the object based on the at least one reconstructed image.

### CROSS-REFERENCE TO RELATED APPLICATION

This application claims benefit of German patent application No. 10 2025 118 014.8, filed on May 10, 2025, which is hereby incorporated by reference in its entirety.

### TECHNICAL FIELD

The invention relates to methods and corresponding systems for reconstructing images affected by defective pixels for quality inspection of an object comprising integrated circuit patterns. The generated quality information can be used for evaluating the quality of an object comprising integrated circuit patterns, for example, for measuring positions of structures on a photolithography mask or wafer, or for detecting defects in a photolithography mask or wafer, and subsequently for improving the photolithography mask or wafer manufacturing process, for repairing the photolithography mask or wafer or for discarding the photolithography mask or wafer.

### BACKGROUND

Semiconductor manufacturing involves precise manipulation, e.g., etching, of materials such as silicon at very fine scales in the range of nm. A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum design node can be below 10 nm, for example 7 nm or 5 nm, and is approaching design node size below 3 nm in near future, which corresponds to a feature size or critical dimension below 20 nm on the wafer. While the complexity and dimensions of the semiconductor structures are growing into the 3^{rd} dimension, the lateral dimensions of integrated semiconductor structures are becoming smaller. Producing the small structure dimensions imaged onto the wafer requires photolithography masks or templates for nanoimprint photolithography with ever smaller structures or pattern elements. The production process of photolithography masks and templates for nanoimprint photolithography is, therefore, becoming increasingly more complex and, as a result, more time-consuming and ultimately also more expensive. With the advent of EUV photolithography scanners, the nature of masks changed from transmission-based to reflection-based patterning.

On account of the tiny structure sizes of the pattern elements of photolithography masks, it is not possible to exclude errors during mask production. The resulting defects can, for example, arise from degeneration of objects comprising integrated circuit patterns or particle contamination. Hence, in semiconductor process control, inspection, review, and metrology of objects comprising integrated circuit patterns play a crucial role to monitor systematic defects. Defects detected during quality assurance processes can be used for root cause analysis, for example, to modify, repair or even discard the object comprising integrated circuit patterns.

For metrology or defect detection in objects comprising integrated circuit patterns, usually an image of the object comprising integrated circuit patterns is acquired using an optical system and is compared to a reference image. The image and the reference image can be aligned before the comparison. Deviations between the image and the reference image can indicate a defect. Deviations between the image and the reference image can also be used for measuring relative locations of structures in the object comprising integrated circuit patterns. In case the absolute locations of the structures are known, the deviations can be used to measure absolute locations of structures in the object comprising integrated circuit patterns.

A problem arising in the comparison of the image and the reference image are effects of defective pixels in the image and/or the reference image. These effects are, for example, visible as dark lines. When comparing the image to the reference image, such effects of defective pixels lead to false positive defect detections or false measurements. To prevent false positive defect detections or false measurements, the image sensor is usually exchanged. In addition, cameras with defective pixels are usually already discarded during production. This leads to an increased amount of electronic waste during the inspection of objects comprising integrated circuit patterns and during image sensor or camera production, and to a waste of resources.

It is, therefore, an aspect of the invention to increase the image sensor lifetime in optical systems for the inspection of objects comprising integrated circuit patterns. A further aspect is to conserve resources and reduce electronic waste. It is another aspect to reduce false positive defect detections or false measurements in optical systems for the inspection of objects comprising integrated circuit patterns.

The aspects are achieved by the invention specified in the independent claims. Advantageous embodiments and further developments of the invention are specified in the dependent claims.

### SUMMARY

Embodiments of the invention concern methods and corresponding systems for quality inspection of objects comprising integrated circuit patterns.

An embodiment of the invention comprises a method for providing a reconstructed image of an object comprising integrated circuit patterns, the method comprising: providing at least one image of an object comprising integrated circuit patterns acquired by an optical system comprising one or more image sensors, at least one of the image sensors comprising one or more defective pixels; reconstructing at least one image comprising effects of defective pixels by reducing the effects of defective pixels.

By reconstructing effects of defective pixels in an image, the image can still be used in downstream tasks that require high quality images without having to replace an image sensor. Thus, the image sensor lifetime is extended and a waste of resources is prevented. In addition, image sensors or cameras that would have been discarded directly after production due to effects of defective pixels can be put to use, thereby preventing a waste of resources. By implementing the method on an embedded system, e.g., in a camera, of the optical system, the reconstruction of the image can be carried out in real-time.

An embodiment of the invention refers to a computer-implemented method for quality inspection of an object comprising integrated circuit patterns using an optical system, the optical system comprising at least one image sensor having one or more defective pixels, the method comprising: providing one or more images of the object acquired by the optical system, wherein at least one of the images comprises effects of the one or more defective pixels; reconstructing pixel values in at least one of the images at locations affected by the defective pixels using a reconstruction method, wherein one or more parameters of the reconstruction method are selected based on at least one parameter of the optical system used to acquire the one or more images; and detecting one or more defects in the object and/or determining positions of structures in the object based on the at least one reconstructed image. Thus, the method can be used for defect detection and/or metrology, e.g., for measuring positions of structures of the object or for measuring deviations of structures of the object from a nominal or reference position.

Parameters of the reconstruction method may comprise, for example, kernel parameters, regularization parameters, filter sizes, weighting factors, neighborhood sizes, or parameters of a machine learning model.

The at least one parameter of the optical system may comprise, for example, a numerical aperture, a pixel size of at least one image sensor, an imaging wavelength, or a parameter related to an expected noise level (e.g., photon noise, detector noise, signal-to-noise models or acquisition settings).

The method provides an improvement over conventional techniques for handling defective pixels. In particular, the method does not merely reconstruct pixel values using generic image-domain techniques, but instead selects one or more parameters of the reconstruction method based on at least one parameter of the optical system used to acquire the image. Conventional approaches, such as interpolation, filtering, or inpainting, operate independently of the underlying image formation process and do not take into account physical properties of the imaging system. In contrast, the claimed approach incorporates optical system parameters, such as numerical aperture, pixel size, imaging wavelength, or a parameter related to an expected noise level of the at least one image sensor and/or the one or more acquired images, thereby adapting the reconstruction to physical constraints of the imaging process, including spatial frequency limitations.

This results in at least one reconstructed image that is more consistent with the true object structure and reduces artefacts that could otherwise lead to false defect detections or inaccurate measurements.

By adapting the reconstruction method to parameters of the optical system, the reconstruction becomes consistent with the underlying image formation process, resulting in reduced reconstruction artefacts and improved reliability of downstream quality inspection, in particular with respect to defect detection and metrology.

In particular, selecting parameters of the reconstruction method based on optical system parameters allows the reconstruction to respect spatial frequency limitations imposed by the optical system, for example by a numerical aperture.

In some embodiments, the selection of pixels used for reconstruction, including the size and shape of a neighborhood around a defective pixel, is determined based on at least one parameter of the optical system.

In some embodiments, parameters of the reconstruction method are selected based on a parameter related to an expected noise level of the at least one image sensor or the one or more acquired images.

In an example, the reconstruction method comprises a regression function, and one or more parameters of the regression function are selected based on at least one parameter of the optical system.

In some embodiments, the reconstruction method accounts for a spatial frequency limitation of the optical system, for example a spatial frequency limitation resulting from a numerical aperture of the optical system.

Defective pixels may comprise at least one of dead pixels, hot pixels, or pixels with fixed output values. In an example, reconstructing pixel values is performed only for pixel values exceeding a threshold indicative of defective pixel behavior.

In some embodiments, one or more parameters of the reconstruction method and/or one or more hyperparameters of a regression function are selected based on an imaging wavelength of the optical system.

In an example, at least two images are reconstructed and averaged. By providing two or more reconstructed images of the object that are averaged, the image acquisition time and, thus, the quality inspection time can be reduced, since less light and, thus, a shorter exposure time is required for each image.

In an example, at least one of the provided images does not contain effects of defective pixels, and the at least one reconstructed image and the at least one image without effects of defective pixels are averaged. By providing two or more images of the object that are averaged, the image acquisition time and, thus, the quality inspection time can be reduced, since less light and, thus, a shorter exposure time is required for each image.

In an example, effects of defective pixels are detected in the at least one image using image processing or a machine learning model that is trained to map at least one image acquired by an optical system to locations of effects of defective pixels in the at least one image. Effects of defective pixels can also be detected from a calibration image acquired by the optical system using a calibration object, for example a calibration object that does not or only minimally absorb light. The likelihood of defective pixels scales with the size of the image sensor. Thus, for larger image sensors, the reduction of effects of defective pixels is particularly beneficial.

In an example, effects of defective pixels in the at least one image are reduced by reconstructing missing information from the at least one image using a regression function. The regression function may comprise a kernel-ridge regression function using a sinc-kernel.

In an example, one or more parameters of the reconstruction method may be optimized using images of objects comprising integrated circuit patterns and corresponding images with simulated effects of defective pixels.

In particular, one or more hyperparameters of the regression function may be selected according to parameters of the optical system. One or more hyperparameters of the regression function may be optimized using images of objects comprising integrated circuit patterns and corresponding images with simulated effects of defective pixels.

In an example, the regression function is partially pre-computed using pre-defined locations relative to the effects of defective pixels in the image.

The regression function may be a one-dimensional function that reconstructs pixel values from pixels along a line in the at least one image. The regression function may also be a two-dimensional function that uses different basis functions and/or different hyperparameters in each dimension of the at least one image.

According to an aspect of the invention, effects of defective pixels are reduced using an inpainting method.

In an example, the effects of defective pixels are reduced using a machine learning model, the machine learning model being configured to map at least one image of an object comprising integrated circuit patterns obtained by an optical system to at least one image with reduced effects of defective pixels.

In an example, the effects of defective pixels are reduced by iteratively reconstructing the at least one image in the signal domain and in the spectral domain.

In an example, reconstructing pixel values comprises weighting pixel values used for reconstruction. The weighting may depend on a distance from a location affected by a defective pixel and/or on a confidence measure associated with the pixel values.

In an example, reconstruction is performed locally using pixel values within a neighborhood of a location affected by a defective pixel, wherein the neighborhood is selected based on at least one parameter of the optical system.

According to an example, the optical system comprises a plurality of image sensors, and reconstructing pixel values comprises combining information from the plurality of image sensors.

According to an embodiment of the invention, a method for quality inspection of an object comprising integrated circuit patterns comprises: providing at least one reconstructed image of an object comprising integrated circuit patterns using a method described above; and using the at least reconstructed image for quality inspection of the object comprising integrated circuit patterns.

The method for quality inspection of an object comprising integrated circuit patterns may further comprise providing at least one reference image of the object comprising integrated circuit patterns and using the at least one reconstructed image and the at least one reference image for quality inspection of the object comprising integrated circuit patterns.

The method for quality inspection of an object comprising integrated circuit patterns may further comprise providing at least one reference image of the object comprising integrated circuit patterns that is acquired using the same optical system or another optical system comprising at least one image sensor with one or more defective pixels, reducing effects of defective pixels of the at least one image sensor in the at least one reference image to reconstruct the at least one reference image, and using the at least one reconstructed image and the at least one reconstructed reference image for quality inspection of the object comprising integrated circuit patterns.

In an example, detecting one or more defects in the object based on the at least one reconstructed image comprises: providing at least one reference image of the object; registering the at least one reconstructed image with the at least one reference image; and detecting defects in the object based on a deviation between the registered images.

In an example, determining positions of structures in the object based on the at least one reconstructed image comprises determining positional deviations of structures in the object.

In an example, the method further comprises controlling at least one manufacturing process parameter of a manufacturing process for the object based on the detected one or more defects and/or the determined positions of structures in the object.

In an example, the method further comprises modifying the object comprising integrated circuit patterns using a repair apparatus based on the detected one or more defects and/or the determined positions of structures in the object comprising at least one of (i) depositing one or more materials onto the object comprising integrated circuit patterns, (ii) removing one or more materials from the object comprising integrated circuit patterns, or (iii) locally modifying a property of the object comprising integrated circuit patterns.

The method may be computer-implemented.

According to an embodiment of the invention, an optical system for acquiring an image of an object comprising integrated circuit patterns comprises: an image sensor with one or more defective pixels configured for acquiring an image of an object comprising integrated circuit patterns, and an embedded system configured for reconstructing an image of an object comprising integrated circuit patterns according to any of the methods described above.

According to an embodiment of the invention, an optical system for quality inspection of an object comprising integrated circuit patterns comprises: at least one image sensor with one or more defective pixels for acquiring an image of an object comprising integrated circuit patterns; one or more processing devices; one or more machine-readable hardware storage devices comprising instructions that are executable by one or more processing devices to perform operations comprising a method for quality inspection of an object comprising integrated circuit patterns as described above.

The optical system may comprise at least one embedded system configured for reconstructing at least one image of an object comprising integrated circuit patterns as described in any of the methods above.

A further embodiment may comprise a computer program comprising instructions which, when the program is executed by a computer, cause the computer to carry out a method for inspecting an object comprising integrated circuit patterns according to any of the examples or aspects according to an embodiment described above.

A further embodiment may comprise a data carrier signal carrying the computer program.

A further embodiment may comprise a computer-readable medium, on which a computer program executable by a computing device is stored, the computer program comprising code for executing a method for inspecting an object comprising integrated circuit patterns according to any of the examples or aspects according to an embodiment described above.

The invention described by examples and embodiments is not limited to the embodiments and examples but can be implemented by those skilled in the art by various combinations or modifications thereof.

### BRIEF DESCRIPTION OF DRAWINGS

FIG. 1 illustrates an exemplary transmission-based optical system, e.g., a deep ultraviolet (DUV) optical system;

FIG. 2 illustrates an exemplary reflection-based optical system, e.g., an extreme ultra-violet light (EUV) optical system;

FIG. 3 illustrates effects of defective pixels during quality inspection of objects comprising integrated circuit patterns:

FIG. 4 shows a flowchart illustrating a method for improving an image of an object comprising integrated circuit patterns according to an embodiment of the invention;

FIG. 5 illustrates the reconstruction of an image comprising effects of defective pixels;

FIGS. 6A and 6B show the accuracy of the reconstruction of missing information in an image using a regression function based on a sinc kernel in a noise-free and a noisy image;

FIG. 7 illustrates pre-computing a regression function from predefined relative locations in the image;

FIG. 8 illustrates a U-Net that can be used to reconstruct effects of defective pixels in images of objects comprising integrated circuit patterns obtained by optical systems;

FIG. 9 illustrates training data for training a machine learning model for reconstructing images of objects comprising integrated circuit patterns affected by defective pixels;

FIGS. 10A-10F show reconstruction results of images affected by defective pixels for different regression methods and the Papoulis-Gerchberg algorithm;

FIG. 11 shows a flowchart illustrating a method for quality inspection of an image of an object comprising integrated circuit patterns according to an embodiment of the invention;

FIGS. 12A-12F illustrate quality inspection results for images and reference images with and without prior reconstruction of effects of defective pixels;

FIGS. 13A and 13B show corresponding structures in a reference image and an image that are registered to measure positions of structures on an object comprising integrated circuit patterns in an optical metrology system;

FIGS. 14A-14C show structures in a reference image and corresponding structures in an image that are registered to detect defects on an object comprising integrated circuit patterns in an optical inspection system; and

FIG. 15 shows a system for quality inspection in an image of an object comprising integrated circuit patterns according to an embodiment of the invention.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

In the present application, the term “reconstructed image” and “improved image” may in some embodiments refer to the same image.

The optical systems herein can use illumination light of different wavelengths, e.g., transmission-based optical systems 10 or reflection-based optical systems 10′ such as EUV systems.

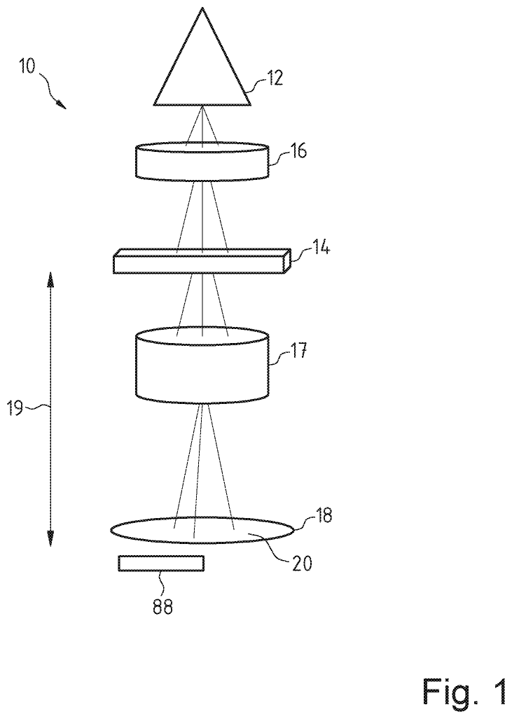

FIG. 1 illustrates an exemplary transmission-based optical system 10 for measuring structures of objects comprising integrated circuit patterns using DUV light. Major components are a light source 12, which may be a deep-ultraviolet (DUV) excimer laser source or a broadband light source, imaging optics which, for example, define the partial coherence and which may include optics that shape radiation from the light source 12, an object comprising integrated circuit patterns 14, illumination optics 16 that illuminate the object comprising integrated circuit patterns 14 and projection optics 17 that project an image of the object comprising integrated circuit patterns onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(θₘₐₓ), wherein n is the refractive index of the media between the substrate and the last element of the projection optics 17, and θₘₐₓ is the largest angle of the beam exiting from the projection optics 17 that can still impinge on the wafer plane 18. The radiation distribution at the wafer plane 18 is imaged by an image sensor 20 of a camera, e.g., a charge coupled device (CCD) or complementary metal oxide semiconductor (CMOS) sensor, to generate an image that is used for measuring tasks. For example, the image sensor 20 can include an array of independently addressable sensor elements or pixels.

In the present document, the terms “illumination”, “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 3-100 nm).

Illumination optics 16 may include optical components for shaping, adjusting and/or projecting radiation from the light source 12 before the radiation passes the object comprising integrated circuit patterns 14. Projection optics 17 may include optical components for shaping, adjusting and/or projecting the radiation after the radiation passes the object comprising integrated circuit patterns 14. The illumination optics 16 exclude the light source 12, the projection optics exclude the object comprising integrated circuit patterns 14.

Illumination optics 16 and projection optics 17 may comprise various types of optics, including refractive optics, reflective optics, apertures and catadioptric optics, for example. Illumination optics 16 and projection optics 17 may also include components operating according to any of these design types for directing, shaping or controlling the projection beam of radiation, collectively or singularly.

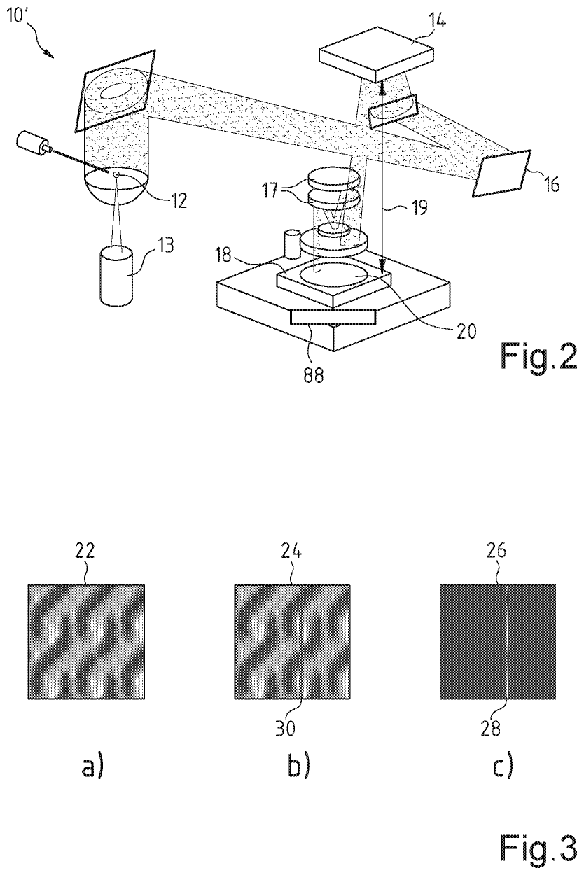

FIG. 2 illustrates an exemplary reflection-based optical system 10′ for measuring structures of objects comprising integrated circuit patterns using extreme ultraviolet (EUV) light. Major components are a light source 12 in the form of an EUV plasma source that is ignited by an IR-laser 13, illumination optics 16 which, for example, define the partial coherence and which may include optics that shape radiation from the light source 12, an object comprising integrated circuit patterns 14, and projection optics 17 that project an image of the object comprising integrated circuit patterns onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(θₘₐₓ), wherein n is the refractive index of the media between the substrate and the last element of the projection optics 17, and θₘₐₓ is the largest angle of the beam exiting from the projection optics 17 that can still impinge on the wafer plane 18. The radiation distribution at the wafer plane 18 is imaged by an image sensor 20 of a camera to generate an image.

An optical system 10, 10′ such as the ones shown in FIGS. 1 and 2 can be used to acquire an image of the object comprising integrated circuit patterns that is used for generating registration information for an image of an object comprising integrated circuit patterns and a reference image of the object comprising integrated circuit patterns.

An optical system refers to a system that uses light to obtain an image of an object comprising integrated circuit patterns. It illuminates the object comprising integrated circuit patterns with light from an illumination source and projects the reflected or transmitted light from the object comprising integrated circuit patterns surface to a camera sensor array. Optical systems comprise, for example, optical inspection systems, optical mask qualification systems, and optical metrology systems.

An optical inspection system refers to an optical system used to detect defects in an object comprising integrated circuit patterns by acquiring and analyzing aerial images of the object comprising integrated circuit patterns or one or more sections thereof. In particular, inspection systems comprise actinic photomask inspection systems

An optical mask qualification system refers to a system that is used to acquire an image of a portion of an object comprising integrated circuit patterns, thereby emulating settings of a photolithography system, e.g., illumination and imaging parameters. The acquired image is of a higher quality than an image acquired by an optical inspection system, e.g., of a reduced noise level. The portions of the object comprising integrated circuit patterns can comprise potential defect locations detected using an optical inspection system for further review. The acquired image can be used to examine the effect of a potential defect on a printed wafer, to verify that objects comprising integrated circuit patterns are defect-free, whether a repair attempt has been successful or for critical dimension estimation.

An optical metrology system refers to a system that is used to take measurements of structures in an object comprising integrated circuit patterns by acquiring an image of the object comprising integrated circuit patterns.

A photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

FIG. 3 illustrates problems arising during quality inspection of photolithography masks that are caused by effects of defective pixels in an image sensor of the optical system. Defective pixels in an image sensor can, for example, be due to an electronic failure or due to contamination of the image sensor. The image 22 is acquired by an image sensor without defective pixels, whereas the reference image 24 is acquired by an image sensor including a defective pixel. There may also be cases, where the image 22 and the reference image 24 are affected by defective pixels in the image sensors. In case of scanning cameras, as shown in FIG. 3, a single defective pixel affects a whole pixel line in the reference image 24. Depending on the type of camera, this may lead to effects of defective pixels 30 in the form of a vertical line in the reference image 24 or to single or clusters of defective pixels in the image 22 or reference image 24. The difference image 26, thus, contains large differences, which are not due to defects but to the defective pixels of the image sensor. These differences lead to false positive defect detections 28 or to incorrect measurements of structure locations. To prevent such false positive defect detections or incorrect measurements, the image sensor or the whole camera is usually replaced in the optical system, leading to electronic waste, a waste of resources and increased costs for quality inspection of objects comprising integrated circuit patterns.

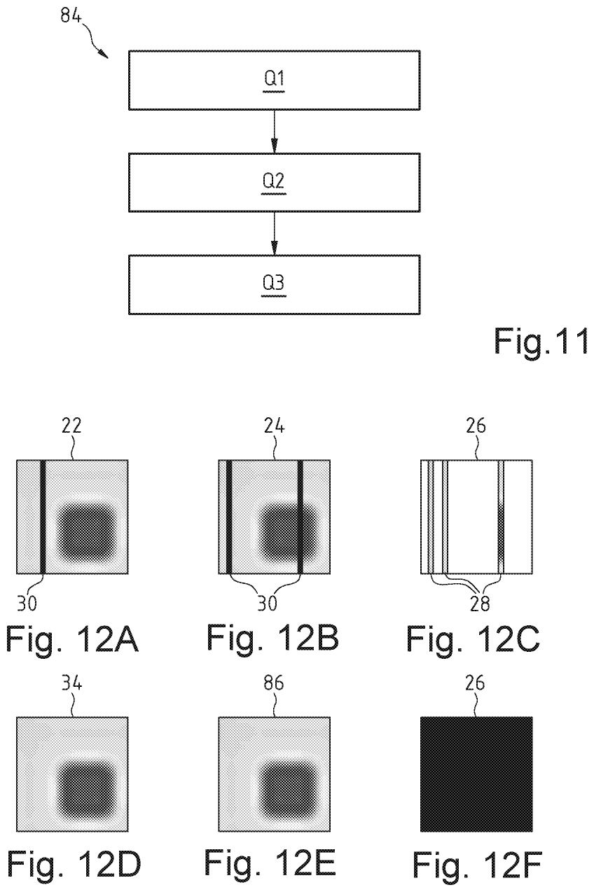

According to an embodiment of the invention illustrated in a flowchart in FIG. 11, a computer-implemented method for quality inspection of an object comprising integrated circuit patterns using an optical system, the optical system comprising at least one image sensor having one or more defective pixels, comprises: providing one or more images of the object acquired by the optical system, wherein at least one image comprises effects of the one or more defective pixels in a step Q1; reconstructing pixel values in the at least one image at locations affected by the defective pixels using a reconstruction method, wherein one or more parameters of the reconstruction method are selected based on at least one parameter of the optical system used to acquire the one or more images in a step Q2; and detecting one or more defects in the object and/or determining positions of structures in the object based on the at least one reconstructed image in a step Q3.

By reducing effects of defective pixels of the at least one image sensor in the at least one image, the method according to the invention takes into account the specific conditions of the optical system, that is the state of the image sensor. In this way, the quality inspection of objects comprising integrated circuit patterns is less affected by these defective pixel effects. Thus, the accuracy of the quality inspection is improved leading to less false positive defect detections and more accurate measurements of structures in the object comprising integrated circuit patterns. For this reason, image sensors comprising defective pixels do not have to be exchanged but can be used for a longer time. Thus, their lifetime is extended, electronic waste is reduced and less resources are wasted.

The term “parameter of the optical system” as used herein refers to one or more physical and/or statistical characteristics of the imaging process, including but not limited to: optical parameters (e.g., numerical aperture, wavelength), sampling parameters (e.g., pixel size), acquisition parameters (e.g., exposure time), noise-related parameters (e.g., signal-to-noise ratio, detector noise model).

In some embodiments, reconstructing pixel values at locations affected by defective pixels is performed using a reconstruction method having one or more parameters that are selected based on at least one parameter of the optical system used to acquire the image. Such parameters of the optical system may comprise, for example, a numerical aperture, a pixel size, an imaging wavelength, or a parameter related to an expected noise level of the image sensor or the acquired image. By selecting parameters of the reconstruction method in dependence on such optical system parameters, the reconstruction can be adapted to physical and/or statistical properties of the image formation process, thereby improving the accuracy of the reconstructed pixel values and reducing artefacts. In addition, the lifetime of cameras is prolonged and electronic waste is reduced. This principle can be applied to different reconstruction methods, including regression-based methods, inpainting methods, and machine learning-based methods. Also in these embodiments, one or more parameters of the reconstruction method may be selected based on at least one parameter of the optical system.

In some embodiments, one or more parameters of the reconstruction method are selected based on one or more parameters of the optical system used to acquire the image. Such parameters of the optical system may comprise, for example, a numerical aperture, a pixel size of the image sensor, an imaging wavelength, or a parameter related to an expected noise level of the image sensor or the acquired image. The numerical aperture may define spatial frequency limitations of the optical system and, thus, influence the bandwidth of the image signal. The pixel size may determine the sampling of the image and, in combination with the numerical aperture, define a sampling regime relative to a Nyquist limit. The imaging wavelength may affect resolution and diffraction behavior of the optical system. A parameter related to an expected noise level may reflect photon statistics, sensor noise, or acquisition conditions such as exposure time or illumination intensity. By selecting parameters of the reconstruction method based on such optical system parameters, the reconstruction can be adapted to physical and/or statistical properties of the image formation process, thereby improving the accuracy of reconstructed pixel values and reducing artefacts. In particular, such parameter selection may ensure that the reconstruction method respects spatial frequency constraints imposed by the optical system and avoids introducing image content that is not physically supported by the imaging process.

In some embodiments, a parameter selection module is configured to determine one or more parameters of the reconstruction method based on one or more parameters of the optical system by applying predefined relationships, calculations, or mappings.

For example, parameters of the reconstruction method may include one or more of a kernel bandwidth parameter, a neighborhood size, a filter size, a regularization parameter, or weighting factors. These parameters may be selected based on optical system parameters including a numerical aperture, a pixel size, an imaging wavelength, and/or a parameter related to an expected noise level.

In some embodiments, the parameter selection module determines the parameters of the reconstruction method using one or more of: (i) analytical relationships derived from physical models of the optical system, (ii) empirical mappings obtained from calibration data, or (iii) optimization procedures based on training data.

For example, if the numerical aperture increases, the spatial resolution of the optical system increases, and the parameter selection module may reduce a kernel bandwidth parameter or a neighborhood size to reflect the higher spatial frequency content of the image. If the pixel size increases, the parameter selection module may increase the kernel bandwidth parameter or neighborhood size to account for reduced spatial sampling. If the imaging wavelength increases, the parameter selection module may increase the kernel bandwidth parameter to reflect a lower optical resolution. If an expected noise level increases, the parameter selection module may increase a regularization parameter or a kernel bandwidth parameter to improve robustness against noise.

In this way, the parameters of the reconstruction method are systematically adapted to the physical and statistical properties of the optical system.

In particular, a bandwidth parameter h of a kernel function used in the reconstruction may be selected based on optical system parameters. For example, the bandwidth parameter h may be determined as:

$$h = c \frac{p}{NA}$$

where p denotes a pixel size of the image sensor, NA denotes a numerical aperture of the optical system, and c is a proportionality constant.

The relationship between the bandwidth parameter h and the optical system parameters can be understood from the spatial resolution properties of the imaging system. The numerical aperture NA, optionally in combination with an imaging wavelength λ, defines a spatial resolution limit of the optical system. In particular, the optical system acts as a low-pass filter with a cutoff spatial frequency proportional to NA/λ, thereby limiting the highest spatial frequencies that can be observed in the acquired image.

At the same time, the pixel size p determines the spatial sampling of the image. Together, the numerical aperture NA and the pixel size p define a sampling regime relative to the bandlimited image signal.

The bandwidth parameter h of the kernel function controls the spatial extent and effective frequency response of the reconstruction. By selecting h proportional to p/NA, the kernel is adapted to the spatial resolution and sampling density of the optical system. In this way, the reconstruction operates on a spatial scale that is consistent with the physical image formation process and avoids introducing spatial frequency components that are not supported by the optical system.

In some embodiments, the bandwidth parameter h may additionally depend on the imaging wavelength λ, since the wavelength influences the diffraction-limited resolution of the optical system. For example, larger wavelengths may result in larger values of h, reflecting a reduced spatial resolution.

The parameter selection module may receive input data including at least one of a numerical aperture, a pixel size, an imaging wavelength, or a parameter related to an expected noise level, and may compute one or more reconstruction parameters based on the input data. The parameter selection module may be implemented as software executed by one or more processing devices, as part of an embedded system of the optical system, or as dedicated hardware. In some embodiments, the parameter selection module is integrated into a camera system and determines the reconstruction parameters in real time during image acquisition.

In some embodiments, the selection of one or more parameters of the reconstruction method comprises computing the parameters based on analytical relationships derived from the imaging process.

In some embodiments, one or more parameters of the reconstruction method are selected based on a parameter related to an expected noise level of the image sensor or the acquired image. The expected noise level may depend on factors such as photon statistics, illumination intensity, exposure time, sensor characteristics, or readout noise. By taking such noise-related parameters into account, the reconstruction method can be adapted to balance fidelity to the observed data with robustness against noise. For example, weighting factors, regularization parameters, or kernel parameters of a regression function may be adjusted depending on the expected noise level, such that stronger regularization or smoothing is applied in higher-noise conditions, while finer detail is preserved in lower-noise conditions. Similarly, neighborhood sizes or confidence weights assigned to pixel values used for reconstruction may be adapted based on noise estimates. This allows the reconstruction to reduce noise amplification and avoid overfitting to noisy measurements, thereby improving the stability and accuracy of the at least one reconstructed image and enhancing the reliability of subsequent quality inspection steps.

For example, in some embodiments, the selection or adjustment of the parameters of the reconstruction method based on a parameter related to an expected noise level is performed by the parameter selection module.

The parameter selection module may receive as input a parameter related to an expected noise level of the image sensor or the acquired image. The expected noise level may be represented, for example, by a noise variance σ², a signal-to-noise ratio, or a noise model associated with the image acquisition process.

Based on the expected noise level, the parameter selection module determines one or more parameters of the reconstruction method. In particular, the parameter selection module may adjust a regularization parameter, a kernel parameter, a neighborhood size, or weighting factors used in the reconstruction.

For example, in the case of a regression-based reconstruction method, a regularization parameter λ_{reg} may be selected as a function of the expected noise level, such as:

λ_{ref}=kσ²

where σ² denotes the noise variance and k is a proportionality constant.

In this way, higher noise levels result in stronger regularization, thereby reducing sensitivity to noise and preventing overfitting to noisy pixel values, while lower noise levels allow for a more detailed reconstruction.

In some embodiments, a kernel parameter, such as a bandwidth parameter of a kernel function, may also be adjusted based on the expected noise level. For example, increased noise levels may lead to a larger bandwidth parameter, resulting in a smoother reconstruction, whereas lower noise levels may allow for a smaller bandwidth parameter to preserve fine spatial details.

In further embodiments, weighting factors associated with pixel values used for reconstruction are selected based on the expected noise level, such that pixel values with lower confidence due to noise are assigned lower weights.

In this way, the reconstruction method is adapted not only to the optical resolution of the system but also to statistical properties of the acquired image, resulting in improved stability and accuracy of the reconstructed image.

In some embodiments, the expected noise level varies spatially across the image. In such cases, the parameter selection module may determine a spatially varying noise estimate σ²(x), where x denotes a spatial location in the image.

The spatially varying noise estimate may be obtained, for example, from a noise model of the image sensor, from calibration data, from local image statistics, or from acquisition parameters such as local signal intensity or exposure conditions.

Based on the spatially varying noise estimate σ²(x), the parameter selection module may determine spatially varying parameters of the reconstruction method. For example, a spatially varying regularization parameter λ_{reg}(x) may be selected as:

λ_{ref}(x)=kσ²(x)

where k is a proportionality constant.

In this way, regions with higher noise levels are reconstructed using stronger regularization, resulting in smoother estimates, while regions with lower noise levels allow for more detailed reconstruction.

In some embodiments, additional parameters such as kernel bandwidth or weighting factors are also adapted spatially. For example, weighting factors associated with pixel values may be reduced in regions of higher noise, or kernel bandwidth may be increased locally to suppress noise amplification.

In this way, the reconstruction method adapts locally to statistical properties of the image, improving robustness and reconstruction accuracy in the presence of spatially varying noise.

In some embodiments, parameters of the reconstruction method are jointly selected based on both optical system parameters and noise-related parameters.

In some embodiments, the dependence of the reconstruction method on parameters of the optical system comprises explicitly adapting one or more reconstruction parameters to corresponding physical properties of the optical system. For example, a filter size, kernel width, or neighborhood size used for reconstruction may be selected based on a combination of numerical aperture and pixel size, thereby reflecting a spatial resolution and sampling regime of the optical system.

The selection of a filter size, a kernel width, or a neighborhood size used for reconstruction may, for example, be performed by the parameter selection module.

The parameter selection module may receive as input one or more parameters of the optical system, including at least a numerical aperture NA and a pixel size p of the image sensor. Based on these parameters, the parameter selection module determines a spatial scale associated with the resolution and sampling of the imaging system.

In particular, the numerical aperture NA defines a spatial resolution limit of the optical system, optionally in combination with an imaging wavelength λ. The smallest resolvable spatial structures are on the order of λ/NA. The pixel size p defines the spatial sampling of the image relative to this resolution limit.

Based on these relationships, the parameter selection module may determine the filter size, kernel width, or neighborhood size such that the reconstruction operates on a spatial scale consistent with the optical resolution and sampling of the system.

For example, a neighborhood radius r may be selected as:

$$r = k \frac{λ}{NA}$$

where k is a scaling factor.

In discrete pixel units, the neighborhood size may be determined as:

$${r}_{pixels} = k \frac{λ}{NA \cdot p}$$

where rₚᵢₓₑₗₛ denotes a radius expressed in pixel units.

In this way, the neighborhood size reflects the number of pixels corresponding to the optical resolution limit of the system. The scaling factor k may, for example, selected based on an expected noise level, such that larger neighborhoods are used in higher-noise conditions to increase robustness.

In some embodiments, the kernel width of a reconstruction kernel is selected proportionally to the neighborhood size, such that both are adapted to the same spatial scale.

In some embodiments, the filter size or neighborhood shape may additionally depend on the sampling regime. For example, in cases of anisotropic sampling or scanning acquisition, the neighborhood may be elongated along a direction with higher sampling density or higher signal correlation.

In this way, the reconstruction method uses pixel values that are physically correlated with the missing information and avoids incorporating pixel values that are outside the effective spatial support defined by the optical system.

A regularization parameter or weighting factor may be selected based on a parameter related to an expected noise level, such that increased noise levels result in stronger smoothing or regularization during reconstruction. Similarly, parameters of a regression function, such as a bandwidth parameter of a kernel function, may be selected based on an imaging wavelength and/or a numerical aperture, thereby reflecting diffraction-related resolution limits. In this way, parameters of the reconstruction method are not selected arbitrarily, but are systematically derived from physical and/or statistical properties of the optical system, ensuring that the reconstruction remains consistent with the image formation process.

The selection of parameters of a regression function, such as a bandwidth parameter of a kernel function or a regularization parameter, may be performed by the parameter selection module.

The parameter selection module may receive as input one or more parameters related to an expected noise level of the image sensor or the acquired image. The expected noise level may be represented, for example, by a noise variance σ², a signal-to-noise ratio, or a noise model associated with the image acquisition process.

Based on the expected noise level, the parameter selection module determines one or more parameters of the regression function. In particular, the parameter selection module may adjust a bandwidth parameter h of a kernel function and/or a regularization parameter λ_{reg}.

In some embodiments, the regularization parameter λ_{reg} is selected as a function of the expected noise level, for example:

λ_{reg}=kσ²,

where σ² denotes the noise variance and k is a proportionality constant.

In this way, higher noise levels result in stronger regularization, thereby reducing sensitivity to noise and preventing overfitting of the regression function to noisy pixel values.

In some embodiments, the bandwidth parameter h of the kernel function is also selected based on the expected noise level. For example, for higher noise levels, a larger bandwidth parameter h may be selected, resulting in a smoother regression function that averages over a larger spatial region. For lower noise levels, a smaller bandwidth parameter h may be selected to preserve finer spatial details.

In some embodiments, the bandwidth parameter h is determined based on both optical system parameters and noise-related parameters. For example, an initial value of h may be determined based on optical system parameters, and subsequently adjusted based on the expected noise level.

In this way, the regression function is adapted both to the physical resolution of the optical system and to statistical properties of the acquired image, resulting in improved reconstruction accuracy and robustness.

In some embodiments, reconstructing pixel values comprises weighting pixel values used for reconstruction based on a distance from a location affected by a defective pixel and/or based on a confidence measure associated with the pixel values.

The term “confidence measure” refers to a quantity indicating a reliability of a pixel value in an image. For example, the confidence measure may depend on one or more of a noise level of the pixel, a signal-to-noise ratio, a deviation from expected intensity values, or whether the pixel is located near a defective pixel. Pixels with higher noise levels or suspected defects may be assigned a lower confidence measure, while pixels with stable and consistent values may be assigned a higher confidence measure.

In some embodiments, weighting depends on a distance between a pixel used for reconstruction and the location affected by the defective pixel, such that pixel values closer to the affected location are assigned higher weights than pixel values further away. For example, a distance-based weighting function may decrease monotonically with increasing distance.

In some embodiments, the weighting combines both distance and confidence measure. For example, a weight wᵢ associated with a pixel value at location xᵢ may be determined as:

wᵢ=f(dᵢ)·g(cᵢ)

where dᵢ denotes a distance from the location affected by the defective pixel, cᵢ denotes a confidence measure associated with the pixel value, and f and g denote weighting functions. In some embodiments, f may be a decreasing function of distance, and g may be an increasing function of the confidence measure.

In this way, pixel values that are both spatially close to the affected location and associated with a high confidence measure contribute more strongly to the reconstruction, thereby improving robustness and reconstruction accuracy.

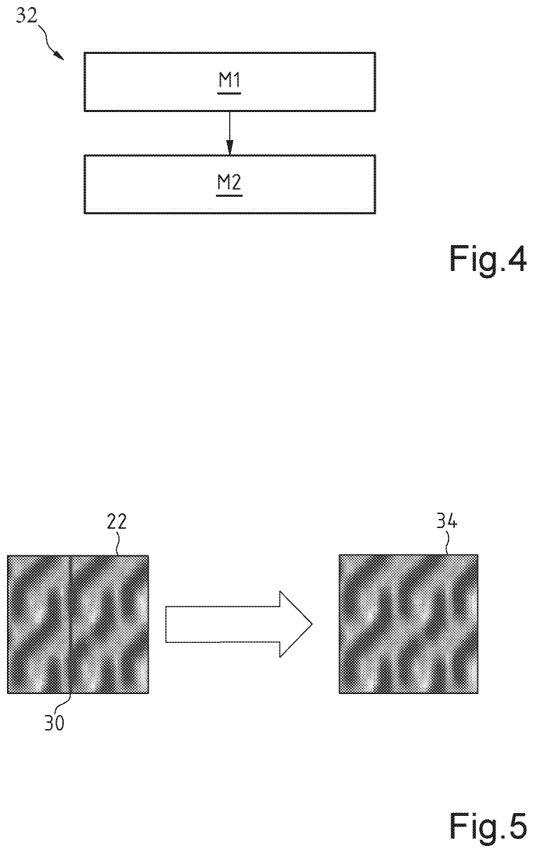

According to a further embodiment of the invention illustrated in FIG. 4, a method 32 for providing an improved image of an object comprising integrated circuit patterns comprises: providing at least one image of an object comprising integrated circuit patterns acquired by an optical system comprising one or more image sensors, at least one of the image sensors comprising one or more defective pixels in a step M1; reconstructing at least one image comprising effects of defective pixels by reducing the effects of defective pixels, and obtaining the improved image using the at least one reconstructed image in a step M2.

FIG. 5 shows an example of an image of a photolithography mask obtained by an optical system that contains effects of defective pixels 30. The effects of defective pixels are reconstructed from image information outside the affected regions leading to a reconstructed image 34. The at least one reconstructed image may then be used for quality inspection of the photolithography mask, in particular to detect one or more defects in the object and/or determine positions of structures in the object based on the at least one reconstructed image.

By reducing effects of defective pixels of the image sensor in the image, the method according to the invention takes into account the specific conditions of the optical system, that is the state of the image sensor of the optical system. By reconstructing the missing information due to the defective pixels of the image sensor, image sensors comprising defective pixels do not have to be exchanged but can be used for a longer time. Thus, their lifetime is extended, electronic waste is reduced and less resources are wasted.

An integrated circuit pattern can comprise semiconductor structures. An object comprising integrated circuit patterns can refer, for example, to a photolithography mask or a wafer. In a photolithography mask the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

Quality inspection refers to the process of determining quality parameters of an object comprising integrated circuit patterns. Quality inspection comprises defect detection and metrology. Defect detection aims at locating defects in the object comprising integrated circuit patterns, e.g., their location, their size, their type, their shape, their total number, their number per area, or statistical measurements of the defects such as an average size, an intensity distribution, etc. Metrology aims at measuring relative or absolute locations of structures in the object comprising integrated circuit patterns.

Defective pixels in an image sensor can have different causes, for example, an electronic failure or contamination of the image sensor. Effects of defective pixels in an image refer to artefacts in the image that are caused by defective pixels in the image sensor (that was used to acquire the image). Such artefacts comprise, for example, single or multiple pixels, pixel clusters or pixel lines showing deviations in intensity or color, e.g., dark pixels or pixel lines, or random intensity or color values.

An image of an object comprising integrated circuit patterns can refer to different kinds of images of the object comprising integrated circuit patterns, e.g., to a two-dimensional image, a three-dimensional image, a stack of images or a volumetric three-dimensional image that can, for example, be processed slice by slice. An image can be an image of a complete object comprising integrated circuit patterns or of a section of the object comprising integrated circuit patterns. For quality inspection, a reference image is often required to derive information on defects or measurements.

According to an example, an image refers to an aerial image. An aerial image indicates the radiation intensity distribution of an optical system in a wafer plane for a given object comprising integrated circuit patterns. It refers to the image that is formed by the projection of light, e.g., of EUV or DUV wavelength, through an object comprising integrated circuit patterns onto an imaging sensor, e.g., CCD or CMOS arrays. The aerial image, thus, simulates the structures on the surface of a wafer after printing. A wafer plane refers to a plane within the resist on top of the wafer. The image sensor can be part of a camera adapted for acquiring images at predetermined wavelengths. The camera can be an EUV camera, and/or a camera comprising a time delay integration (TDI) sensor. In preferred embodiments, an image acquisition method comprises the use of an EUV camera comprising a TDI sensor. The camera's image sensor can accordingly be an EUV image sensor, i.e., an image sensor that is sensitive to EUV light. EUV light is light in the extreme ultraviolet spectral range with wavelengths between 5 nm and 100 nm, in particular with wavelengths between 5 nm and 30 nm. Especially the EUV light can have a wavelength of 13.5 nm. In preferred embodiments, the image acquisition method comprises illuminating an object comprising integrated circuit patterns with actinic radiation within the EUV wavelength range. EUV radiation reflected from the mask is then projected on an imaging sensor of an EUV camera via accordingly adapted projection optics.

A reference image refers to an image of an object comprising integrated circuit patterns or of a section thereof, that represents (at least approximately) the same structures as the image of the object comprising integrated circuit patterns. The reference image can be of the same type as the image or of a different type such as a SEM image or a design image. A reference image can comprise an acquired image of the same object comprising integrated circuit patterns, e.g., at a different point in time, using a different optical system, using the same optical system with different settings, using a different section of the same object comprising integrated circuit patterns that contains the same structures, etc. An image can also be used as a reference image for itself, e.g., a mirrored image can be used as a reference image in case the image contains structures that are self-symmetrical. A reference image can comprise an acquired image of a different object comprising integrated circuit patterns comprising the same structures as the image of the object comprising integrated circuit patterns using the same or a different optical system. A reference image can also comprise a simulated image. An image can be simulated from a model of an object comprising integrated circuit patterns using image simulation methods. For example, rigorous simulation methods such as finite difference time domain (FDTD) or rigorous coupled wave analysis (RCWA) can be used that are known to a person skilled in the art. Since they require long computation times, fast but less accurate approximations such as the thin element approximation (TEA) that relies on a thin mask assumption can be used. To obtain fast and accurate results, simulation methods that are based on physical models but still do not rely on the thin mask assumption can be used, e.g., the not quite rigorous method disclosed in WO 2024 141484 A1 and in DE 10 2022 135 019 A1. Apart from physical simulations, trained machine learning models can be used to simulate images from designs. A reference image can also comprise a model of the object comprising integrated circuit patterns, e.g., a design file or some other representation of the structures on the object comprising integrated circuit patterns. The appearance of the model of the object comprising integrated circuit patterns can be adapted to look like an acquired image of the object comprising integrated circuit patterns, e.g., using simulation software or machine learning models for appearance modification such as generative adversarial models or conditional generative adversarial models. In case of a simulated reference image, defective pixel effects only occur in the image but not in the reference image.

A model of an object comprising integrated circuit patterns, e.g., a photolithography mask, refers to a representation of the object comprising integrated circuit patterns or a section thereof. A model of a wafer can describe the model of the photolithography mask used to manufacture the wafer. The model can, for example, comprise a computer readable file, such as a computer-aided design (CAD) file, a graphic data system (GDS) file, an Oasis file or a technical drawing. A model of an object comprising integrated circuit patterns can comprise descriptions of structures or patterns on the object comprising integrated circuit patterns, e.g., of their location and shape. For example, the structures on the object comprising integrated circuit patterns, in particular curvilinear structures, can be described as mathematical functions, e.g., in the form of vertices, edges, polygons, curves, contours, Splines, non-uniform rational B-splines (NURBS), Bézier curves, etc. The shape of structures can further be described using properties such as side wall angles or corner rounding, etc. The patterns and structures on an object comprising integrated circuit patterns can also be described by an image, e.g., a 2D image or a 3D image (e.g., a volume of voxels or a number of 2D slices of a volume), that represents structures or patterns on the object comprising integrated circuit patterns. The image can comprise image elements, e.g., pixels or voxels. The image can, for example, be a binary image indicating the location of structures on the object comprising integrated circuit patterns. The image can contain one, two or more channels. The channels can also comprise further information of the object comprising integrated circuit patterns. The patterns and structures on an object comprising integrated circuit patterns can also be described using text, e.g., describing locations of structures such as the location of absorber structures or the order of layers in a multilayer, parameters of functions representing (curvilinear) structures, types of structures or patterns such as “lines and spaces”, “contact hole”, “lines”, “dots”, “squares”, “crosses”, “letter Z”, “spline”, “semicircle”, or high-level descriptions such as “regular arrangement of lines with a specific distance”, etc. Apart from the location and shape of structures on the object comprising integrated circuit patterns, the model can comprise further properties of the object comprising integrated circuit patterns, e.g., material properties of the structures on the object comprising integrated circuit patterns such as complex refractive indices of materials contained in the object comprising integrated circuit patterns, electric permittivities, magnetic permeabilities, or derived representations. The model can also comprise size or dimensional properties of the object comprising integrated circuit patterns such as the thicknesses of layers in a multilayer of an EUV mask or the thickness of other layers, or the dimension of structures. A model of an object comprising integrated circuit patterns can comprise optical proximity correction or inverse lithography based patterns. A model can refer to the model of a complete object comprising integrated circuit patterns, or it can refer to the model of a section of the object comprising integrated circuit patterns. A model of an object comprising integrated circuit patterns can, for example, be stored in a database.

In an example, at least two images are reconstructed and averaged. In an example, at least one of the provided images does not contain effects of defective pixels, and the at least one reconstructed image and the at least one image without effects of defective pixels are averaged. Thus, at least one image of the object is provided, and at least one of these images is reconstructed due to effects of defective pixels. In case there are two or more images (with or without effects of defective pixels), these images are, preferably, acquired simultaneously. But some or all of them can also be acquired sequentially. The at least one image of the object contain at least partially the same section of the object. By providing two or more images (reconstructed or not) of the object that are averaged, the image acquisition time and, thus, the quality inspection time can be reduced, since less light and, thus, a shorter exposure time is required for each image. During quality inspection of an object comprising integrated circuit patterns, the object can, thus, be inspected faster due to the reduced image acquisition time.

Instead of averaging the at least one reconstructed image and, optionally, further images, other methods can be used to obtain the at least one reconstructed image. For example, a reconstructed image may be selected from the at least one reconstructed image and, optionally, further images.

For example, in case two or more images of the object are provided, a reconstructed image can also be obtained by replacing the image information at locations comprising effects of defective pixels by the image information of one of the other images that are not affected by effects of defective pixels in these locations. This may be achieved using location-dependent weights during the averaging operation.

In an example, at least three images are acquired of the object comprising integrated circuit patterns. One of these images is acquired using an image sensor with one or more defective pixels. This image is reconstructed. Finally, the reconstructed image is averaged with the other at least two images without effects of defective pixels.

Averaging refers to some linear combination of the images. Thus, each image can be weighted with a different weighting factor. For example, the average could be computed by

a=w₁l₁+w₂l₂+w₃l₃

where w₁+w₂+w₃=1.

Each weight wᵢ of an image can be location-dependent, i.e., it can vary with the image location. Thus, each weight may refer to a matrix of weights for the respective image. In this way, for example, locations comprising effects of defective pixels can have a low value, whereas locations without effects of defective pixels can have a high value. A weight may also be 0, meaning that one of the images or reconstructed images is not used.

The weighting factors w₁, w₂, and w₃ may, for example, be determined based on image quality metrics associated with the respective images.

For example, the weighting factors are selected based on a signal-to-noise ratio or an expected noise level of each image. Images with higher signal-to-noise ratio may be assigned higher weights, while images with lower signal-to-noise ratio are assigned lower weights.

In some embodiments, the weighting factors are determined based on the presence of defective pixels. For example, an image comprising effects of defective pixels may be assigned a reduced weight compared to an image without such effects.

In further embodiments, the weighting factors are determined based on a combination of image quality metrics, such as signal-to-noise ratio, detected defective pixel locations, or confidence measures associated with pixel values.

For example, weighting factors may be determined according to:

$${w}_{i} = \frac{{q}_{i}}{{E}_{j} {q}_{j}}$$

Where qᵢ represents a quality measure associated with image i.

The quality measure qᵢ may, for example, be derived from a noise estimate or a confidence measure as described above.

In some embodiments, the weighting factors may vary spatially across the image. In such cases, each weight wᵢ may correspond to a spatially varying weighting function wᵢ(x), where x denotes a spatial location. For example, locations affected by defective pixels may be assigned lower weights, while unaffected regions are assigned higher weights.

In this way, the combination of multiple images is adapted to image quality and reliability, resulting in improved reconstruction accuracy.

Locations of effects of defective pixels in an image can be detected or provided. The locations can be indicated as a list of coordinates or a binary image, for example. Throughout this description, locations may refer to pixel positions or sub-pixel positions, e.g., to coordinates of pixels but also to coordinates between pixels.

Locations of effects of defective pixels can be detected using image processing, for example, by identifying pixels of a specific intensity or color or within a specific intensity or color range, e.g., defined by one or more thresholds.

Locations of effects of defective pixels in the form of a line or other shapes can, for example, be detected using a Hough transform, a specific filter or by template matching.

Locations of effects of defective pixels can be detected using a machine learning model that is trained to map an image acquired by an optical system to locations of effects of defective pixels. Such a machine learning model may be a Convolutional Neural Network (CNN), a U-Net or a Transformer, etc. The training data may comprise pairs of images acquired by one or more optical systems and corresponding locations of effects of defective pixels in the images, e.g., in the form of a binary image, a set of bounding boxes, a list of coordinates, etc. The machine learning model can be trained using a loss function, e.g., a cross-entropy loss between the predicted locations and the ground truth locations. Optimization can, for example, be carried out using a backpropagation variant or the Adam optimizer.

Alternatively, effects of defective pixels can be detected from a calibration image acquired by the optical system using a clear object comprising integrated circuit patterns. Effects of defective pixels can be detected from dark locations in the calibration image.

The detection of effects of defect pixels in the image is advantageous, in case no prior knowledge about defective pixels of the image sensor is available. Furthermore, the number of defective pixels can increase during use of the image sensor.

In case the effects of defective pixels in an image are already known, e.g., from previous images or from a previous calibration image, they can be provided. For example, the locations of effects of defective pixels can be loaded from a database. The database can be updated when further defective pixels occur in the image sensor. To this end, defective pixels in an image sensor can be detected in acquired images in a regular interval to keep the list up-to-date. Providing effects of defective pixels instead of detecting them in an acquired image reduces the computation time.

There are different ways for reducing effects of defective pixels in an image sensor. According to an example, effects of defective pixels are reduced by reconstructing missing information (pixel values) at these locations from the image.

To this end, a regression function can be used. A regression function maps image locations to expected intensity or color values at these locations based on a set of support points, e.g., image locations and corresponding intensity or color values in other parts of the image. Examples of regression functions are linear regression functions, polynomial regression functions, exponential regression functions, logistic regression functions or kernel ridge regression functions. Regression functions can be defined with respect to a set of basis functions or kernels, e.g., polynomial basis functions, radial basis functions, Spline basis functions, Fourier basis functions, Gaussian basis functions, etc.

For example, a linear combination of basis functions can be used as a regression function. Due to the use of basis functions, the regression function can represent nonlinear relationships between the variables. At the same time, the regression function is linear in its coefficients and, thus, simple to optimize and fast to compute.

Regression functions are beneficial, since they prevent overfitting to noise in the image due to an implicit regularization of the method, e.g., by using a limited degree or number of basis functions or by regularizing the coefficients.

According to a preferred example, the regression function comprises a kernel-ridge regression function with a sinc-kernel. In ridge regression, the goal is to minimize the following objective function, which includes both the loss term and the regularization term. Let (xᵢ,yᵢ), i=1, . . . n indicate the coordinates xᵢ and corresponding intensity or color values yᵢ in the image, and let αⱼ indicate coefficients associated with each kernel function. Then ridge regression minimizes the following objective function for the coefficients α

$$F ( α ) = {\sum }_{i = 1}^{n} {( {y}_{i} - {\sum }_{j = 1}^{n} {α}_{j} K ( {x}_{i} , {x}_{j} ) )}^{2} + λ {\sum }_{j = 1}^{n} {α}_{j}^{2} , \qquad ( 1 )$$

where λ refers to a weighting factor. By penalizing high coefficient values, overfitting is prevented. Various kernel functions K can be used, e.g., a linear kernel, a Gaussian kernel, a Laplace kernel or a sigmoid kernel. In this preferred example, a sinc kernel is used

$$K ( {x}_{i} , {x}_{j} ) = sin c ( {x}_{i} - {x}_{j} ) = \frac{sin ( \frac{1}{h} ‖ {x}_{i} - {x}_{j} ‖ )}{\frac{1}{h} ‖ {x}_{i} - {x}_{j} ‖} .$$

The hyperparameter h>0 is a scaling parameter that controls the scaling of the input differences, influencing the effective width of the kernel's main lobe and its frequency cutoff. The hyperparameter h controls the effective bandwidth of the kernel and is therefore also referred to as a bandwidth parameter.

Optimization can be carried out by taking the derivative of F, setting it to 0 and solving the resulting system of equations. The ridge regression function based on the sinc kernel used to reconstruct intensity or color values at coordinates x is then:

$$f ( x ) = {\sum }_{i = 1}^{n} {α}_{i} sin c ( x - {x}_{i} ) .$$

Due to the numerical aperture of the illumination pupil of the optical system the image intensity is a bandlimited function. In such cases, the sinc kernel ensures a near-perfect reconstruction of bandlimited signals when sampled at the appropriate rate. It corresponds to the reproducing kernel of the associated Hilbert space. The representer theorem states that for regularized empirical risk minimization problems in a reproducing kernel Hilbert space (RKHS), the optimal solution can be expressed as a finite linear combination of kernel functions evaluated at the training data points. Therefore, ridge regression based on the sinc kernel allows for a near-perfect reconstruction of the missing information (e.g., missing intensity or color values) in the image obtained by the optical system—if the image is noise-free. This is particularly important, since the introduction of artefacts into the image during the reconstruction should be prevented to prevent the introduction of false positive defect detections.

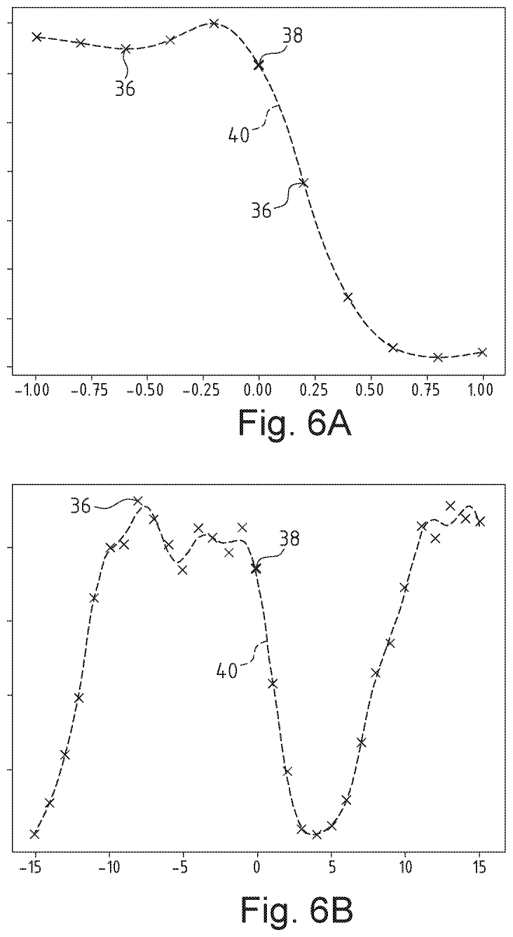

FIG. 6A shows the result of ridge regression based on a sinc kernel for reconstructing missing information at location x=0 in a noise-free image. The horizontal axis represents a spatial coordinate x, which may correspond to a position in the image, for example a pixel coordinate or a physical position in the object space. The vertical axis represents an intensity value associated with the image, such as a grayscale intensity or a color channel value. The units of the horizontal axis may be given in pixel units or in physical units, such as micrometers, depending on the representation of the image. The vertical axis may represent normalized intensity values or sensor output values, for example digital counts.

The support data points shown in FIG. 6A correspond to known pixel values in the vicinity of a location affected by a defective pixel. These pixel values represent measured intensities of the object acquired by the optical system and are used by the regression function to reconstruct the missing information at the affected location. The use of such support data points is based on the observation that image intensities vary smoothly within a spatial region defined by the optical resolution of the system. Accordingly, neighboring pixel values are correlated and contain information that can be used to estimate the missing value at the affected location, in particular due to the bandlimited nature of the image formed by the optical system. Based on a set of support data points 36, the regression function 40 perfectly reconstructs the true data point 38 at x=0.

FIG. 6B shows the result of ridge regression based on a sinc kernel for reconstructing missing information at location x=0 in a noisy image. The horizontal and vertical axes correspond to those described for FIG. 6A. In particular, the horizontal axis represents a spatial coordinate, and the vertical axis represents intensity values. In contrast to FIG. 6A, the support data points in FIG. 6B are affected by noise, such that the measured intensity values deviate from the underlying noise-free signal. Based on a set of support data points 36, the regression function 40 reconstructs the true data point 38 at x=0 with a small error, which is due to the noise in the image.

According to an example, one or more hyperparameters of the regression function are selected according to parameters of the optical system. For example, the bandwidth parameter h in the sinc kernel above can be selected with respect to parameters of the optical system, e.g., with respect to the pixel-size, the imaging aperture, an expected noise level related to photon 1s numbers, etc. The bandwidth parameter can, for example, be selected proportionally to the pixel size and anti-proportionally to the NA, representing the theoretical, ideal system. In some embodiments, the bandwidth parameter h is selected proportionally to the pixel size and inversely proportional to the numerical aperture of the optical system. For example, for a pixel size p of 5 μm and a numerical aperture NA of 0.5, an initial value of the bandwidth parameter may be selected as:

$$h = c \frac{p}{NA} = c \frac{μ m}{0.5} = c \cdot 10 μ m$$

where c is a proportionality constant that may be selected based on empirical calibration or system-specific considerations.

The proportionality constant c may also be selected such that the bandwidth parameter h corresponds to a spatial scale on the order of the optical resolution limit of the system. In addition, the bandwidth parameter h may be adjusted based on an expected noise level of the acquired image. In particular, the expected noise level may depend on photon statistics, such that lower photon counts result in higher noise levels. Furthermore, the bandwidth parameter h may be increased for higher noise levels, resulting in a smoother reconstruction that reduces noise amplification. Conversely, for lower noise levels, the bandwidth parameter h may be reduced to preserve finer spatial details.

For example, the bandwidth parameter h may be selected according to:

h=h₀·(1+α·σ)

where h₀ is an initial bandwidth parameter determined based on optical system parameters, σ represents a noise measure related to photon noise or detector noise, and α is a scaling factor. In this way, the bandwidth parameter h is adapted both to the spatial resolution of the optical system and to the noise characteristics of the acquired image.

The bandwidth parameter may also be selected or refined using empirical or systematic corrections in order to take more details of the system into account.

Empirical corrections may be determined based on calibration data obtained from the optical system. For example, images of calibration objects or representative objects comprising integrated circuit patterns may be acquired, and the bandwidth parameter h may be adjusted such that a reconstruction error between reconstructed images and reference images is minimized.

Systematic corrections may account for known deviations of the optical system from an ideal model. Such deviations may include aberrations of the imaging optics, non-ideal sampling effects, sensor characteristics, or illumination inhomogeneities. In such cases, the bandwidth parameter h may be modified based on predetermined correction factors that compensate for these effects.

In some embodiments, the corrected bandwidth parameter h is determined using a mapping from optical system parameters to kernel parameters, for example using a lookup table, a parametric model, or an optimization procedure. The optimization procedure may use a loss function as described above for hyperparameter selection.

In this way, the bandwidth parameter h can be adapted not only to idealized system parameters but also to actual system behavior, thereby improving reconstruction accuracy.

In addition or alternatively, one or more hyperparameters of the regression function may be optimized using images of objects comprising integrated circuit patterns and corresponding images with simulated effects of defective pixels. Images of objects comprising integrated circuit patterns can be acquired or simulated from a model using a simulation method as described above. For these images, a variant of the image including simulated effects of defective pixels can be generated. For example, dark vertical lines, dark pixels or dark pixel clusters can be introduced into the images to simulate effects of defective pixels. Then one or more hyperparameters of the regression function can be selected to minimize the deviation of the reconstructed images from the original images.

In an example, an original image may be used as a reference image, and a corresponding degraded image may be generated by introducing simulated defective pixel effects, such as pixel dropouts, pixel clusters, or line defects. The regression function is then applied to reconstruct the degraded image, and the hyperparameters are adjusted to minimize a reconstruction error between the reconstructed image and the reference image.

The reconstruction error may be quantified using a loss function, for example a mean squared error or another suitable similarity measure. The hyperparameters may be optimized using an optimization procedure, such as a grid search, gradient-based optimization, or another iterative method.

In some embodiments, the optimization is performed offline, and the resulting hyperparameters are stored and subsequently used during reconstruction of images acquired by the optical system.

While some hyperparameters may be selected with respect to optical system parameters, other parameters may be optimized using images and corresponding images with simulated effects of defective pixels. Alternatively, all hyperparameters are selected with respect to optical system parameters or by optimization.

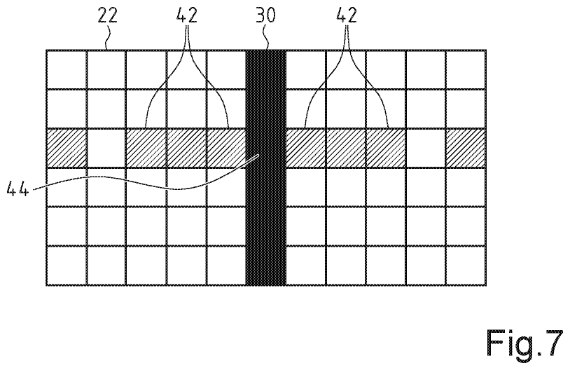

In an example illustrated in FIG. 7, the regression function is partially pre-computed using pre-defined locations 42 relative to the effects of defective pixels 30 in the image 22, such that the pre-computed regression function is a linear combination of pixel values at the pre-defined relative locations 42. Given a location 44 affected by a defective pixel, locations 42 relative to this affected location 44 can be pre-defined, from which the missing information will be reconstructed.

The predefined relative locations 42 may be determined based on geometric, optical, and/or structural considerations. The predefined relative locations may be selected as neighboring pixel locations relative to a location affected by a defective pixel. For example, the predefined relative locations may include pixels in a local neighborhood surrounding the affected location.

In an example, the predefined relative locations are selected based on a spatial resolution limit of the optical system. For example, the extent of the predefined relative locations may be limited to a spatial region on the order of λ/NA, where λ is an imaging wavelength and NA is a numerical aperture of the optical system, such that only pixel values that are physically correlated with the affected location are used.

In some embodiments, the predefined relative locations are selected based on structural characteristics of the object comprising integrated circuit patterns. For example, in the case of line-and-space patterns, the predefined relative locations may be arranged along a direction corresponding to the orientation of the structures, such that pixel values are preferentially selected along directions with higher spatial correlation.

In a further example, the predefined relative locations are defined using a predefined template or pattern that is applied relative to each affected location. Such templates may be determined empirically, for example based on calibration data, or analytically based on properties of the optical system.

In an example, directly neighboring locations can be selected as pre-defined locations 42 that will be used as support points to derive the regression function. In case the effects of defective pixels 30 form a line (e.g., a vertical line), the pre-defined relative locations 42 used to reconstruct a single pixel intensity or color on this line can, for example, comprise locations along an orthogonal line (e.g., a horizontal line).

In an example, in case ridge regression based on a kernel function is used as regression function, the pre-defined locations 42 can be defined relative to the affected location 44 as shown in FIG. 7. As the distance from the affected location x 44 is known for the pre-defined locations xᵢ 42, the kernels K(xᵢ,x)=sinc(xᵢ−x) can be pre-computed in equation (1) without knowing the absolute locations of the pre-defined locations 42 in the image. The resulting pre-computed regression function is linear in the coefficients. This results in a simplified minimization problem that can be solved in less computation time. For each image 22 comprising one or more affected pixels 44, only the coefficients αᵢ have to be computed from the intensity or color values at the pre-defined locations 42 relative to the one or more affected pixels 44 in the image 22.

In some embodiments, the predefined relative locations are selected such that the corresponding regression computation can be reused across multiple pixel locations.

In this way, the predefined relative locations are selected such that they provide relevant and correlated pixel values for reconstructing missing information, while enabling efficient computation through reuse of the predefined configuration.

In an example, the regression function is a one-dimensional function that reconstructs pixel values from pixels along a line in the image as illustrated in FIG. 7. In this way, the reconstruction is very fast due to the simplicity of the regression function. Furthermore, the implementation on an embedded system is simplified in this way. In case of an optical system in form of a scanning microscope with a TDI sensor, for example, missing information at an affected location 44 may be reconstructed using pre-defined locations in a cross scan direction of the optical system.

In an alternative example, the regression function is a two-dimensional function that uses different basis functions and/or different hyperparameters in each dimension of the image. In this way, different properties, e.g., smoothness properties, in different directions of the image can be taken into account. Such differing properties can, for example, be due to different numerical apertures or different pixel sizes in each direction of the image. Thus, the accuracy of the reconstruction is improved.

In some embodiments, reconstructing pixel values at locations affected by defective pixels is performed using pixel values within a local neighborhood of each affected location, wherein the size, shape, and/or orientation of the neighborhood are selected based on at least one parameter of the optical system. For example, the neighborhood may be defined to reflect resolution characteristics of the optical system, such as anisotropies introduced by the imaging optics, scanning direction, or pixel geometry. In this way, the neighborhood may be elongated or oriented along a direction corresponding to structures present in the object, such as line or space patterns, or along directions in which the optical system provides higher resolution or signal quality. The extent of the neighborhood may further depend on parameters such as numerical aperture, pixel size, or other system-dependent resolution limits, thereby ensuring that the reconstruction relies on pixel values that are physically meaningful and correlated with the missing information. By adapting the neighborhood selection to the optical system, the reconstruction can more accurately capture underlying structures in the object comprising integrated circuit patterns while avoiding the inclusion of irrelevant or weakly correlated pixel values.

According to an embodiment, the size, shape, and/or orientation of the neighborhood used for reconstruction is determined by the parameter selection module based on one or more parameters of the optical system. The parameter selection module may receive as input parameters including a numerical aperture NA, a pixel size p, and optionally an imaging wavelength λ. Based on these parameters, the parameter selection module determines a spatial resolution limit of the optical system.

In particular, the optical system may be characterized by a spatial resolution on the order of λ/NA. Accordingly, the neighborhood size may be selected such that it corresponds to this spatial resolution. For example, a neighborhood radius r may be selected as:

$$r = k \frac{λ}{NA}$$

where k is a scaling factor. In discrete image coordinates, the neighborhood size may be expressed in pixel units as:

$${r}_{pixels} = k \frac{λ}{NA \cdot p}$$

where p denotes the pixel size. Accordingly, the extent of the neighborhood is defined by the radius r (or rₚᵢₓₑₗₛ in discrete image coordinates), such that only pixel values within this radius are used for reconstruction. In this way, the neighborhood is limited to a spatial region determined by the resolution of the optical system and the sampling defined by the pixel size. Thus, the neighborhood includes pixel values that are spatially correlated with a location affected by a defective pixel, while excluding pixel values that are outside the effective spatial support defined by the optical system. The extent of the neighborhood may further be adjusted based on additional system-dependent resolution limits, such as aberrations or effective sampling constraints.

In an example, the shape of the neighborhood is selected based on properties of the optical system and/or the acquisition process. For example, in systems with isotropic resolution, the neighborhood may be approximately circular or square. In systems with anisotropic resolution or sampling, the neighborhood may be elongated along a direction of higher resolution or stronger signal correlation. Such anisotropies may result from properties of the optical system, including asymmetric numerical aperture, scanning direction, or pixel geometry of the image sensor.

In an example, the orientation of the neighborhood is selected based on a scanning direction of the optical system or based on structural characteristics of the object comprising integrated circuit patterns. For example, in the case of line-and-space patterns, the neighborhood may be oriented along a direction of the structures to improve reconstruction accuracy.

In some embodiments, the neighborhood size is additionally increased in regions of higher noise to improve robustness.

In this way, the neighborhood used for reconstruction is adapted to both physical imaging properties and structural characteristics of the object, resulting in improved reconstruction performance.

Reconstruction may be performed using pixel values that are selected along one or more directions corresponding to structures present in the object, such as line structures. By aligning the selection of pixel values with these structural directions, the reconstruction can more accurately capture the underlying geometry of the integrated circuit patterns and improve the fidelity of the at least one reconstructed image. For example, in the case of line-and-space patterns extending predominantly in a horizontal direction, pixel values for reconstructing a defective pixel may be selected primarily from neighboring pixels along the horizontal direction, while pixels in the vertical direction are given less weight or are not considered.

Apart from regression, missing information in an image due to defective pixels of an image sensor of an optical system can be reconstructed using other methods as well.

In an example, effects of defective pixels are reduced using an inpainting method. In image processing, inpainting is the technique of reconstructing lost or deteriorated parts of an image by filling them in with information extrapolated from the surrounding areas. The goal is to produce a seamless restoration, where the inpainted region is indistinguishable from the original content. Various techniques can be employed for inpainting. Interpolation-based methods estimate missing pixels from known surrounding pixels, using, for example, bilinear interpolation, bicubic interpolation, or spline-based interpolation. While effective for small missing regions, these methods may struggle with large missing areas, especially when complex textures or structures are involved. Exemplar-based or patch-based methods copy and blend patches from known image regions to reconstruct missing areas, using, for example, algorithms like PatchMatch or the Criminisi algorithm. They are particularly useful for inpainting larger missing regions to preserve textures and structures. Machine learning based methods use neural networks such as generative adversarial networks (GANs) or diffusion models to reconstruct missing parts of an image. They can handle complex structures and textures more effectively than traditional interpolation or exemplar-based methods.

According to an example, the effects of defective pixels are reduced using a machine learning model, the machine learning model being trained to map an image of an object comprising integrated circuit patterns obtained by an optical system to an image with reduced effects of defective pixels of the image sensor. In case the image is not affected by defective pixels, the machine learning model should not modify the image.

Optionally, the machine learning model can use some kind of location information as additional input. The location information indicates locations of effects of defective pixels in the image, e.g., using a binary mask, bounding boxes or a list of coordinates, etc. An image-to-image machine learning model can be used such as a U-Net, an autoencoder, a Transformer, a diffusion model, etc.

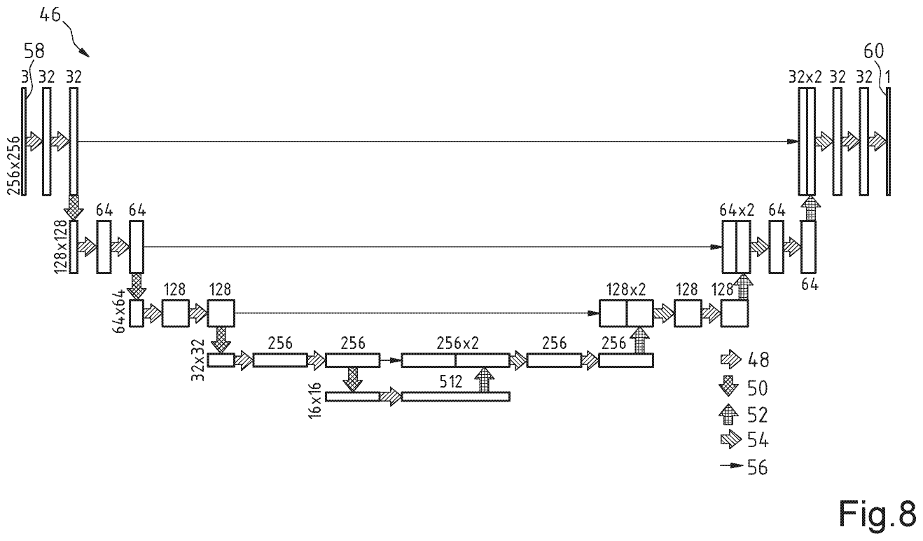

A U-Net is illustrated in FIG. 8. The U-Net 46 comprises different operations that are applied to the input data 58 to generate the output data 60. The numbers next to each layer indicate the layer size. The operations comprise conv 3×3 batch norm operations 48, max pool 2×2 operations 50, up-conv 2×2 operations 52, and skip connections 56.

The machine learning model can be trained by minimizing a loss function, e.g., a cross-entropy loss function.

In some embodiments, the loss function comprises a cross-entropy loss that measures a deviation between predicted outputs of the machine learning model and corresponding ground truth data. For example, in the case where the machine learning model outputs a probability p that a pixel is affected by a defective pixel, a binary cross-entropy loss may be used. The binary cross-entropy loss L for a single pixel can be expressed as:

L=−[y·log(p)+(1−y)·log(1−p)]

where y denotes a ground truth label indicating whether the pixel is affected by a defective pixel (e.g., y=1 for defective and y=0 for non-defective), and p denotes a predicted probability.

In embodiments where multiple classes are predicted, for example different types of defective pixel effects, a categorical cross-entropy loss may be used. For example, the machine learning model may output a probability distribution over a set of classes, and the loss may be computed as:

$$L = - {\sum }_{i} {y}_{i} log ( {p}_{i} )$$

where yᵢ denotes a ground truth label for class i (e.g., in one-hot encoded form), and pᵢ denotes a predicted probability for class i.

Such classes may correspond, for example, to different types of defective pixel effects, such as dead pixels, hot pixels, or pixel clusters. In this case, the categorical cross-entropy loss measures how well the predicted class probabilities match the ground truth class labels.

As an example, the machine learning model may be trained to predict a binary mask indicating locations of effects of defective pixels in an image. In such a case, the cross-entropy loss measures how accurately the predicted mask matches a ground truth mask, thereby enabling the model to learn to identify and correct defective pixel regions.

In some embodiments, one or more parameters of the machine learning model are selected based on at least one parameter of the optical system used to acquire the one or more images.

For example, parameters of the machine learning model may include one or more of: an architecture parameter (e.g., number of layers or receptive field size), a filter size, a stride, a pooling size, or one or more hyperparameters used during training. These parameters may be selected based on optical system parameters including a numerical aperture, a pixel size, an imaging wavelength, and/or a parameter related to an expected noise level.

For example, a receptive field size of the machine learning model may be selected based on a spatial resolution of the optical system, such that the receptive field corresponds to a spatial region on the order of λ/NA. If the pixel size is increased, the receptive field size in pixel units may be increased accordingly. In a further example, one or more training or regularization parameters of the machine learning model may be selected based on an expected noise level of the optical system. For instance, for higher noise levels, the machine learning model may be trained with stronger regularization, noise augmentation, or loss functions that are more robust to noise, whereas for lower noise levels, the training may emphasize preservation of fine structural details.

The machine learning model may be trained using training data that is generated or selected based on parameters of the optical system, such that the trained model implicitly captures the image formation characteristics of the optical system.

In this way, the machine learning model is adapted to the physical and statistical properties of the optical system, thereby improving reconstruction accuracy compared to a generic model.

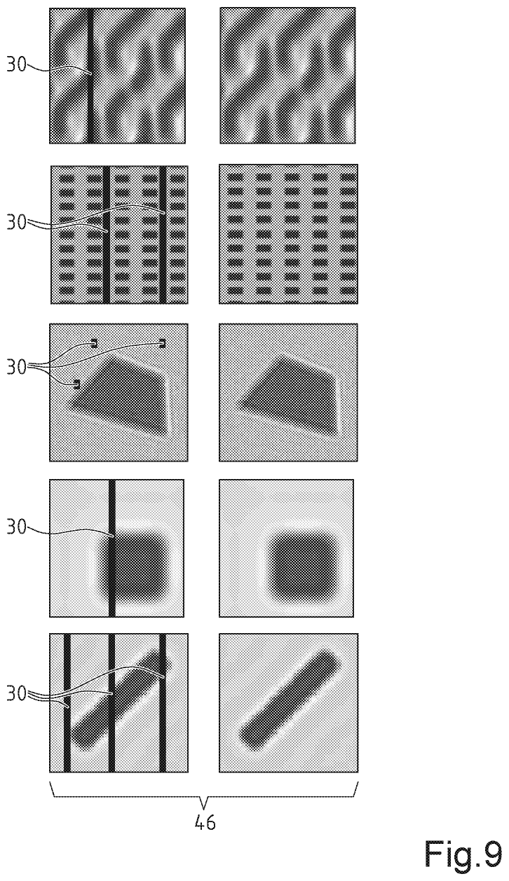

FIG. 9 illustrates exemplary training data 46 comprising images of objects comprising integrated circuit patterns including effects of defective pixels 30 (left) and corresponding images without effects of defective pixels (right). To this end, effects of defective pixels can be simulated in images, e.g., by introducing dark pixels or dark lines into the image.

In an example, the optical system comprises at least one further image sensor configured for acquiring a further image of the object comprising integrated circuit patterns. If a further image sensor comprises defective pixels, the effects of the defective pixels in the further image are reduced using any of the reconstruction methods described above. If a further image sensor does not comprise defective pixels, no reconstruction of the further image is required. The image and the at least one further image may be averaged to obtain an image with a low SNR or at a reduced image acquisition time. This may require sub-pixel alignment of the image sensors. The use of additional image sensors allows for highly accurate or even near-perfect reconstructions of the image. Even though additional image sensors are required, their lifetime or the lifetime of the cameras comprising them is extended.

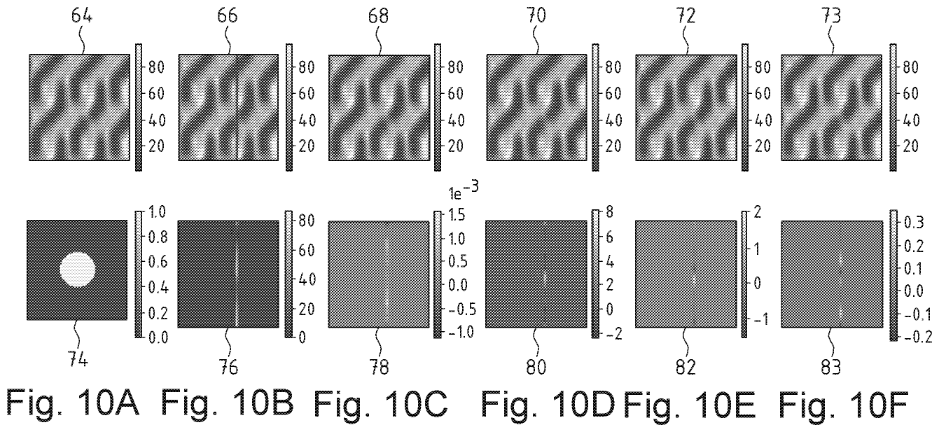

According to an example, the effects of defective pixels are reduced by iteratively reconstructing the image in the signal domain and in the spectral domain. If the image is oversampled and effected by bandlimited white noise, the effects of defective pixels can be reconstructed nearly perfectly. In this case, the pixel-size may be below the Nyquist limit, which is, however, not a necessary prerequisite. The Papoulis-Gerchberg algorithm can be used to reconstruct the missing information in the image. The Papoulis-Gerchberg algorithm is an iterative method for reconstructing missing parts of a band-limited image. It alternates between enforcing the known data (in the spatial or time domain) and imposing a band-limited constraint in the frequency domain. By iteratively projecting between these two domains, the algorithm gradually fills in the missing information, converging to a reconstruction that aligns with both the observed data and the assumed frequency limitations. In this way, a nearly perfect reconstruction of the image is possible as illustrated in FIG. 10C.

FIGS. 10A-10F shows reconstruction results for different regression functions and the Papoulis-Gerchberg algorithm. Column a) of FIG. 10 shows a noise-free image 64 of an object comprising integrated circuit patterns without effects of defective pixels in the first row, and an NA filter 74 corresponding to the numerical aperture of the illumination pupil of the optical system that was used to acquire the image 64 in the second row. Column b) shows an image 66 which corresponds to the image 64 but includes effects of defective pixels 30 in the first row, and a first difference image 76 showing the difference between image 66 including effects of defective pixels and image 64 without effects of defective pixels in the second row. The maximum difference is around 80. Column c) shows a Papoulis-Gerchberg reconstruction 68 of the image 66 including effects of defective pixels in the first row, and a second difference image 78 of the Papulis-Gerchberg reconstruction 68 and the image 64 without effects of defective pixels in the second row. The maximum difference is around 1e-13, so almost 0. Column d) shows a linear regression reconstruction 70 of the image 66 including effects of defective pixels in the first row, and a third difference image 80 of the linear regression reconstruction 70 and the image 64 without effects of defective pixels in the second row. The maximum difference is around 7. Column e) shows a cubic regression reconstruction 72 of the image 66 including effects of defective pixels in the first row, and a fourth difference image 82 of the cubic regression reconstruction 72 and the image 64 without effects of defective pixels in the second row. The maximum difference is around 1.8. Column f) shows a sinc regression reconstruction 73 of the image 66 including effects of defective pixels in the first row, and a fifth difference image 83 of the sinc regression reconstruction 73 and the image 64 without effects of defective pixels in the second row. The maximum difference is around 0.3. These results illustrate that the Papoulis-Gerchberg reconstruction 68 yields almost perfect reconstructions of noise-free images, followed by a sinc regression reconstruction 73, followed by a cubic regression reconstruction 72, followed by a linear regression reconstruction 70. The sinc regression reconstruction 73 is less exact than the Papoulis-Gerchberg reconstruction 68, since it only uses a limited amount of input pixels, while the Papoulis-Gerchberg reconstruction 68 is based on the whole image 66. However, the sinc regression reconstruction 73 requires less computation time. Nevertheless, all of these reconstructions greatly reduce the error due to defective pixels in the image compared to an image without reconstruction.

The different reconstruction methods shown in FIG. 10 are performed as follows.

A Papoulis-Gerchberg reconstruction 68 of the image 66 may be performed as an iterative method that alternates between a spatial domain and a spectral domain. In the spatial domain, pixel values at locations not affected by defective pixels are enforced to remain equal to the measured values, while pixel values at locations affected by defective pixels are updated. In the spectral domain, a band limitation corresponding to the optical system is imposed, for example by applying a frequency filter defined by a numerical aperture of the optical system. These steps are iterated until convergence, resulting in a reconstruction that is consistent with both the observed data and the band-limited nature of the image.

A linear regression reconstruction 70 of the image 66 may be performed by estimating pixel values at locations affected by defective pixels using a linear combination of pixel values at neighboring locations. The coefficients of the linear combination may be determined by minimizing a least-squares error between predicted and observed pixel values in a local neighborhood.

A cubic regression reconstruction 72 of the image 66 may be performed similarly to the linear regression reconstruction, but using higher-order basis functions, such as cubic polynomials. In this case, pixel values are approximated using a polynomial function fitted to pixel values in a neighborhood, allowing for a more flexible representation of local intensity variations.

A sinc regression reconstruction 73 of the image 66 may be performed using a kernel ridge regression approach with a sinc kernel, as described above. In this case, pixel values at locations affected by defective pixels are reconstructed as a weighted sum of kernel functions centered at neighboring pixel locations, wherein the kernel parameters are selected based on properties of the optical system. This approach leverages the band-limited nature of the image and enables accurate reconstruction of missing information.

In all cases, locations affected by defective pixels may be identified using a mask, such that reconstruction is applied selectively at these locations.

According to an embodiment, the at least one reconstructed image is provided using a machine learning model that is trained to map at least one image of an object comprising integrated circuit patterns to at least one reconstructed image of the object, wherein one or more images of the object comprise effects of defective pixels. Thus, instead of using only a single image comprising effects of defective pixels as input, the machine learning model may use additional images of the object with or without effects of defective pixels as input. The output of the machine learning model is at least one reconstructed image. The training data may comprise images comprising the same section of an object comprising integrated circuit patterns with and without effects of defective pixels and corresponding reconstructed images. The corresponding reconstructed images can, for example, be obtained using the same or a different optical system using one or more image sensors without defective pixels, or with a single image sensor without defective pixels and an extended exposure time. The corresponding reconstructed images could also be obtained using any of the methods described above. In this way, the quality of the reconstructed images obtained by the machine learning model would be the same, but the computation time could be reduced as only a single forward pass of the trained machine learning model would be required to obtain the at least one reconstructed image.

The method for quality inspection may further comprise providing a reference image of the object comprising integrated circuit patterns that is used during quality inspection. The reference image may be reconstructed using any of the methods described above.

According to an embodiment of the invention, the method for quality inspection of an object comprising integrated circuit patterns further comprises providing at least one reference image of the object comprising integrated circuit patterns that is acquired using the same optical system or another optical system comprising an image sensor with one or more defective pixels, reducing effects of defective pixels of the image sensor in the reference image to reconstruct the reference image, wherein the reconstructed image and the at last one reconstructed reference image are used for quality inspection of the object comprising integrated circuit patterns.

As illustrated in FIG. 12, for quality inspection of an object comprising integrated circuit patterns an image 22 is acquired using an optical system. A corresponding reference image 24 is acquired using the same or a different optical system. The reference image 24 can be obtained from the same object comprising integrated circuit patterns, e.g., from a different die or a different section of the object comprising the same integrated circuit patterns. The reference image 24 can also be obtained from a different object comprising the same integrated circuit patterns. The image 22 and the reference image 24 comprise effects of defective pixels 30 in the form of vertical dark lines at different locations. The corresponding difference image 26 is non-zero due to the effects of defect pixels 30 and, thus, lead to false positive defect detections 28. Instead of directly computing the difference image 26, the image 22 and the reference image 24 are reconstructed leading to a reconstructed image 34 and a reconstructed reference image 86. The resulting difference image 26 is zero, thus preventing false positive defect detections.

The optical system may comprise more than one image sensor, in particular two, three or four image sensors, configured to obtain two, three or four images comprising the same section of the object. The images may be averaged to collect a sufficient amount of photons per pixel in a reduced image acquisition time. Before averaging the images, the images comprising effects of defective pixels may be reconstructed using any of the reconstruction methods described herein. Alternatively, the reconstruction method may be applied to the image after averaging. In this case, the acquired images are averaged first, and then the averaged image is reconstructed using any of the reconstruction methods described above.

In the following tables, signal-to-noise ratios (SNRs) are compared for difference images of image pairs with and without effects of defective pixels. A first image pair comprises an image including a defect and a defect-free reference image. The image is obtained by averaging images of three image sensors without defective pixels. A second image pair is generated from the first image pair by adding effects of defective pixels in the form of a vertical line through the defect to one of the three images. Different reconstruction methods listed in the table below are applied to this image before averaging. Then the SNR of the difference image of the first image pair and of the difference image of the second image pair is computed for the different reconstruction methods, and the relative SNR change is noted in the following table:

| Reconstruction method | Relative SNR change |
|---|---|
| Without reconstruction | 17.58% |
| Upscaling of remaining sensors | 10.48% |
| Linear regression | 5.38% |
| Cubic regression | 2.45% |
| Sinc kernel ridge regression | 0.71% |

The reconstruction method “Upscaling of remaining sensors” means that the at least one reconstructed image is obtained by averaging only the images of image sensors without defective pixels. Thus, for example, instead of averaging three images, only two images without effects of defective pixels are averaged. This method completely removes effects of defective pixels, but at the same time the SNR is lowered due to the reduced number of photons per pixel in the averaged image.

In the following table, effects of defective pixels are not only included in the image of the second image pair but also in the reference image of the second image pair, and different reconstruction methods are applied to both the image and the reference image of the second image pair. In the following table, the relative SNR change of the difference images of the first image pair and the second image pair is shown:

| Reconstruction method | Relative SNR change |
|---|---|
| Without reconstruction | 15.57% |
| Upscaling of remaining sensors | 18.28% |
| Linear regression | 3.81% |
| Cubic regression | 3.47% |
| Sinc kernel ridge regression | 1.55% |

From these tables, the following conclusions can be drawn: reconstructing an image (and, potentially, a reference image) yields improved SNRs compared to using the original image (and, potentially, reference image) or to upscaling the remaining non-defective sensor images. Among the regression functions, sinc kernel ridge regression yields better results than cubic regression and linear regression. Reconstructing images and reference images containing both effects of defective pixels (second table) yields very similar SNRs compared to only reconstructing images containing effects of defective pixels with defect-free reference images (first table). But the first case (second table) covers a lot more use cases. The results show that the use of an image sensor with defective pixels in combination with the reconstruction of images as described above is feasible, and, thus, saves valuable resources and reduces electronic waste. The small additional SNR loss can be compensated for by using a longer scan-time.

In an example, the reconstruction of an image of an object comprising integrated circuit patterns or the method for improving an image of an object comprising integrated circuit patterns or the method for quality inspection of an object comprising integrated circuit patterns as described above is implemented on an embedded system. One or more embedded systems can be part of the optical system, for example of one or more cameras of the optical system.

In various embodiments of the invention, the embedded system can be a field programmable gate array (FPGA), a digital signal processor (DSP), an arithmetic logic unit (ALU), an application-specific integrated circuit (ASIC), etc. Due to the use of an embedded system, the computation time is strongly reduced, allowing for real-time quality inspection of objects comprising integrated circuit patterns.

In an example, the optical system or a camera in the optical system comprises at least one embedded system that is configured for reconstructing an image of an object comprising integrated circuit patterns, or for carrying out the method for improving an image of an object comprising integrated circuit patterns as described above, or for carrying out the method for quality inspection of an object comprising integrated circuit patterns as described above.

Various quality inspection methods for images of optical systems can be used, e.g., methods that determine positions of structures of an object, positional deviations or defect detection methods.

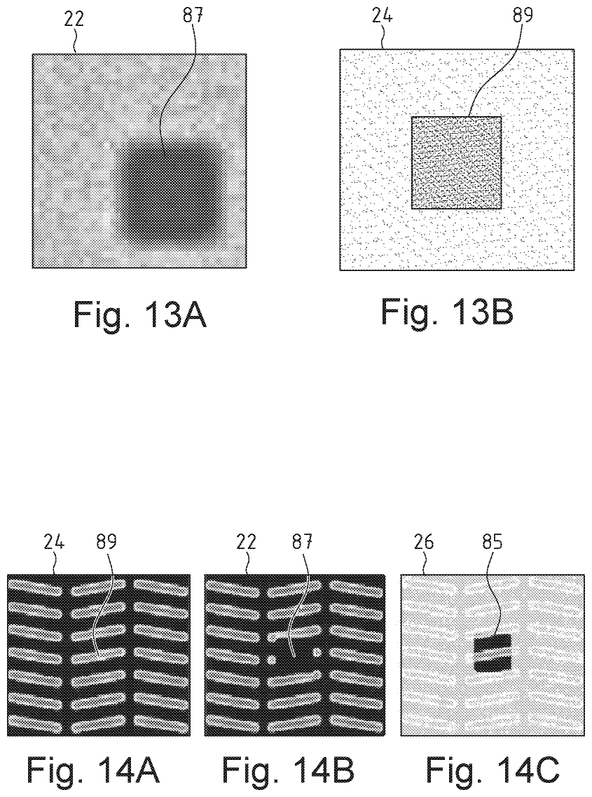

The quality of an object comprising integrated circuit patterns can be evaluated by determining positional deviations of structures 87, 89 on the object comprising integrated circuit patterns as illustrated in FIGS. 13A and 13B. FIG. 13A shows an acquired image 22 of an object comprising integrated circuit patterns comprising a structure 87. FIG. 13B shows a reference image 24, e.g., a model of a photolithography mask, comprising a corresponding structure 89. Provided the position of the corresponding structure 89 in the reference image 24 is known, its absolute position on the object comprising integrated circuit patterns can be derived from registration information, i.e., from the relative displacement of the structure 87 in the image 22 from the corresponding structure 89 in the reference image 24. In case the absolute position of the reference structure 89 on the object comprising integrated circuit patterns is not known, a relative displacement between the structures 87, 89 can be computed. In this way, quality statements can be made about the object comprising integrated circuit patterns, e.g., about an average or a maximum deviation of a position of a structure 87 from a reference position of a reference structure 89, or about a statistic of position deviations. In addition, accurate overlays between consecutive layers of a photolithography mask can be verified, e.g., for structures that traverse consecutive layers. Thresholds can be defined, and in case a threshold is exceeded, the object comprising integrated circuit patterns can be repaired or discarded.

The quality of the object comprising integrated circuit patterns can also be evaluated by detecting defects 85 in the object comprising integrated circuit patterns as illustrated in FIGS. 14A-14C, e.g., by detecting structures 87 in the image 22 (FIG. 14B) that deviate from corresponding structures 89 in the reference image 24 (FIG. 14A). After reducing effects of defective pixels in the image 22 (and potentially in the reference image 24) the at least one reconstructed image and the at least one (potentially reconstructed) reference image are registered with an increased accuracy. Then defects are detected from the at least one registered reconstructed image and reference image or, alternatively, from the at least one reconstructed image and the at least one reference image without reconstruction.

To this end, the registration error, i.e., the deviation of the structures 87 in the image 22 and the reference image 24 after registration can be used, e.g., by computing a difference image 26 and thresholding the difference, or by applying a trained machine learning model that uses the registered image and reference image as input that is mapped to defect indicators, e.g., an image with a defect likelihood. Local structures that lead to a high registration error indicate a defect 85 in the structures of the object comprising integrated circuit patterns. In order to locate the outline of a defect 85, a segmentation of the registration error can, for example, be computed using image processing methods. The segmented defects 85 can be measured. In addition, the defects can be classified, e.g., by using a trained machine learning model. Depending on properties of the defects (e.g., their size, location, type, relevance, etc.) a defect can be reduced, repaired or ignored, or the whole object comprising integrated circuit patterns can be discarded. In this way, quality statements can be made about the object comprising integrated circuit patterns, e.g., about the number of defects per area, the total number of defects, the type of defects, the severity of defects, measurements of defects, etc. Thresholds can be defined, and in case a threshold is exceeded, the object comprising integrated circuit patterns can be repaired or discarded.

Various methods can be used to detect defects in an image of an object comprising integrated circuit patterns, for example, die-to-die methods and die-to-database methods.

The die-to-die principle compares an acquired image of an object comprising integrated circuit patterns with a reference image in the form of another acquired image of the same object comprising integrated circuit patterns, e.g., of the same section or of another section containing the same or similar structures. The discovered deviations are treated as defects. This method is simple to implement, but it requires the availability and time-consuming scanning of two corresponding portions of an object comprising integrated circuit patterns and exact knowledge about their relative position. In addition, it fails in case of systematic repeating defects.

The die-to-database principle compares an image of an object comprising integrated circuit patterns to a reference image from a database, e.g., a simulated image, a golden reference, or a model of a photolithography mask, thereby discovering deviations from the ideal data. Even defects in rare or uncommon structures or systematic repeating defects can be detected in this way. However, die-to-database methods require the availability of a reference image. In addition, they are computationally expensive since they require an intermediate registration step to align the image and the reference image.

Defects can be detected by comparing the image to the reference image, e.g., by computing a difference image. Thresholding techniques can be applied to the difference image, e.g., simple thresholds or adaptive thresholds.

Defect detection methods can include a trained machine learning model. The trained machine learning model could use an image or a pair of an image and a corresponding reference image of an object comprising integrated circuit patterns as input that is mapped to defect indicators. A machine learning model for defect detection can perform various tasks such as defect detection (presence or absence of a defect), defect localization (locating a defect), defect segmentation (computing the area, volume or outline of a defect), defect classification (assigning a defect class to a defect), etc. The machine learning model for defect detection can be trained using training data comprising images and defect annotations, or pairs of images and corresponding reference images and defect annotations.

Defect detection methods can include template matching methods. Template matching is a technique in digital image processing for finding small parts of an image which match a template image. Templates can include simple shapes such as squares, rectangles or circles, or more complicated shapes such as typical defect shapes in photolithography masks. Template matching can, for example, use correlation techniques that correlate sections of the image with one or more templates of a defect to locate the one or more templates in the image.

Defect detection methods can include filtering approaches. Filtering approaches convolve an image with one or more filters. The one or more filters can be used to generate features from sections of the image. Based on these features, classification methods can be applied that classify sections as defective or not. Filters can, for example, comprise edge detectors, Gabor filters, filters obtained from an intermediate layer of a trained convolutional neural network, Fourier filters, highpass filters, HOG features, SIFT features, local binary pattern filters, etc.

In an example, the method further comprises controlling at least one manufacturing process parameter (e.g., a focus, exposure, etc.) for manufacturing an object comprising integrated circuit patterns based on the quality evaluation of the object comprising integrated circuit patterns (e.g., based on the measured positions of the structures in the photolithography mask in case of an optical metrology system, or based on the detected defects in the photolithography mask in case of an optical inspection system).

In some implementations, the information about the defects serve as feedback to improve the process parameters of the manufacturing process, e.g., exposure time, focus, etc., For example, after the defects are identified from a first object comprising integrated circuit patterns or first batch of objects comprising integrated circuit patterns, the process parameters of the manufacturing process are adjusted to reduce defects in a second object comprising integrated circuit patterns or a second batch of objects comprising integrated circuit patterns.

In some implementations, after defects are detected, an object comprising integrated circuit patterns in the form of a photolithography mask can be modified to repair or eliminate the defects. Repairing the defects can include, e.g., depositing materials on the mask using a deposition process, removing materials from the mask using an etching process, or locally modifying a property of the mask. This can, for example, comprise locally modifying at least one of a density, a refractive index, a transparency, or a reflectivity of the photolithography mask.

In the following, a system for correcting defects in a photolithography mask using the techniques above is described. The correction of defects comprises a physical modification of the photolithography mask and is not limited to virtual or simulated modifications. The physical modification of the photolithography mask results in a modified physical structure of the mask that improves subsequent lithographic processing.

In the following, a system configured to correct defects detected by the inspection method described above is described. The system generates control parameters for the repair apparatus, including spatial coordinates, beam intensity, exposure duration, and material deposition or removal parameters. To this end, the system may comprise one or more of the following components: correction determination module, material modification module, control interface to repair equipment, and an optional verification module.

The correction determination module determines one or more correction actions based on the detected defects. The determination may consider defect type (e.g., missing structure, excess material, deformation), defect location and geometry, and predefined correction rules or learned correction strategies.

The material modification module carries out one or more correction actions including at least one of: modifying material of the photolithography mask (e.g., adjusting thickness or properties), removing material from the photolithography mask (e.g., via etching or ablation), or adding material to the photolithography mask (e.g., via deposition or focused beam-induced processes). These operations may be implemented using known mask repair technologies such as focused ion beam (FIB), electron beam induced deposition (EBID), laser-based repair, or other nanofabrication techniques.

The control interface to repair equipment is an interface configured to control a repair apparatus. The fourth subsystem may generate control signals or instructions for a repair apparatus that may perform the physical modification of the photolithography mask. The control signals may define parameters such as position, intensity, duration, or pattern of the repair process.

An optional verification module may be used, after correction, to re-acquire an image of the photolithography mask and re-apply the third subsystem to verify that the defect has been corrected.

The modules are implemented on one or more processing devices comprising processors and memory, and are configured to control physical inspection and repair equipment. In particular, one or more modules are operatively coupled to a mask repair apparatus configured to physically modify the photolithography mask, thereby transforming a physical object based on the detected defects.

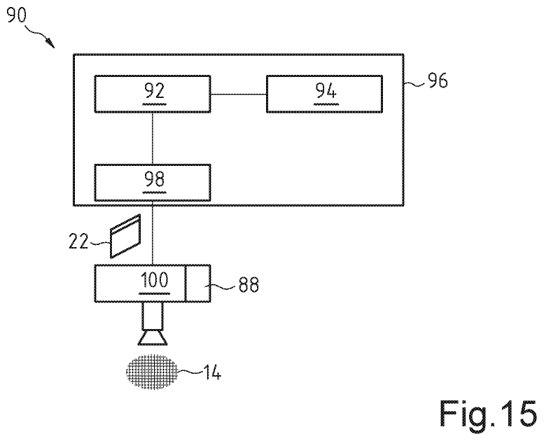

An optical system 10, 10′ for acquiring an image of an object comprising integrated circuit patterns according to an embodiment of the invention, as illustrated for example in FIG. 1 or 2, comprises: at least one image sensor 20 configured for acquiring an image of an object comprising integrated circuit patterns, at least one of the image sensors comprising one or more defective pixels, and at least one embedded system 88 (see FIG. 15) configured for carrying out a method for reconstructing an image of an object comprising integrated circuit patterns as described above or for improving an image as described above. By using the embedded system for reconstructing or improving the image of the object, effects of defective pixels of the at least one image sensor can be directly reduced at very low computation times when acquiring the image, and the at least one reconstructed image can be used for further downstream tasks such as quality inspection. In this way, effects of defective pixels can be reduced in real-time.

Referring to FIG. 15, an optical system 90 for quality inspection of an object 14 comprising integrated circuit patterns according to an embodiment of the invention illustrated in FIG. 13 comprises: a camera 100 having one or more image sensors configured for acquiring an image 22 of an object 14 comprising integrated circuit patterns, at least one of the image sensors comprising one or more defective pixels; one or more processing devices 92; and one or more machine-readable hardware storage devices 94 comprising instructions that are executable by one or more processing devices 92 to perform operations comprising a method for quality inspection of an object 14 comprising integrated circuit patterns as described above. In some examples, the parameter selection module can be implemented using the one or more processing devices 92 in combination with the one or more machine-readable hardware storage devices 94 storing instructions that are executable by the one or more processing devices 92 to perform operations related to the selection of the parameters of the reconstruction method.

The optical system may comprise further image sensors with defective pixels and/or without defective pixels. The image sensors may be arranged in one or more cameras in the optical system. Images acquired by image sensors with defective pixels may be reconstructed using a reconstruction method described above. The at least one reconstructed image and the images acquired by image sensors without defective pixels (if any) may be averaged before being used in a downstream task such as quality inspection. By using two or more image sensors that acquire an image of the same section of the object, the acquisition time can be reduced, since less light is required during image acquisition.

The optical system 90 may further comprise at least one embedded system 88 configured for reconstructing an image of an object comprising integrated circuit patterns, or for carrying out the method for improving an image 22 of an object 14 comprising integrated circuit patterns, as described above. Thus, the optical system 90 for quality inspection uses the at least one embedded system 88 to reconstruct the at least one image 22 of the object 14 comprising integrated circuit patterns requiring very low computation time. The at least one reconstructed image is then used for quality inspection using the one or more processing devices 92 and the one or more machine-readable hardware storage devices 94.

The optical system 90 optionally comprises a database for loading and/or saving data, e.g., parameters of reconstruction methods, parameters of machine learning models, quality inspection parameters, reference images, training data, etc. The data analysis device 96 includes one or more processing devices 92, e.g., implemented as a central processing unit (CPU), graphics processing unit (GPU) or tensor processing unit (TPU). The one or more processing devices 92 can receive the imaging dataset 22 via an interface 98. The one or more processing devices 92 can load program code from a machine-readable hardware-storage device 94, e.g., program code for executing a method for reconstructing an image of an object comprising integrated circuit patterns. The one or more processing devices 92 can execute the program code. The system 90 optionally comprises a user interface, e.g., for entering parameters, for displaying effects of defective pixels, or for monitoring reconstruction or quality inspection results.

Although described for optical inspection of semiconductor structures, the method may be applied to any imaging system affected by defective sensor elements.

In some implementations, each of the one or more processing devices 92 can include one or more processor cores, and each processor core can include logic circuitry for processing data. For example, a processor can include an arithmetic and logic unit (ALU), a control unit, and various registers. Each processor can include cache memory. Each processor can include a system-on-chip (SoC) that includes multiple processor cores, random access memory, graphics processing units, one or more controllers, and one or more communication modules. Each processor can include millions or billions of transistors.

In some implementations, the one or more processing devices can include one or more computers, each computer can include one or more data processors for processing data. The one or more machine-readable hardware storage devices can store one or more computer programs including instructions that when executed by the one or more computers cause the one or more computers to carry out the processes described above. The one or more processing devices can include one or more input devices, such as a keyboard, a mouse, a touchpad, and/or a voice command input module, and one or more output devices, such as a display, and/or an audio speaker.

In some implementations, the one or more processing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may refer to different embodiments, examples, or aspects. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

Embodiments, examples and aspects of the invention can be described by the following clauses:
1. A method 32 for providing an improved image of an object 14 comprising integrated circuit patterns, the method comprising:
   Providing at least one image 22 of an object 14 comprising integrated circuit patterns acquired by an optical system 10, 10′ comprising one or more image sensors 20, at least one of the image sensors comprising one or more defective pixels;
   Reconstructing at least one image 22 comprising effects of defective pixels 30 by reducing the effects of defective pixels 30,
   Obtaining the improved image using the at least one reconstructed image 34.
2. The method of clause 1, wherein at least two images 22 are reconstructed and wherein the improved image is obtained by averaging the at least two reconstructed images.
3. The method of clause 1 or 2, wherein at least one of the provided images 22 does not contain effects of defective pixels, and wherein the improved image is obtained by averaging the at least one reconstructed image 34 and the at least one image 22 without effects of defective pixels.
4. The method of any one of the preceding clauses, wherein effects of defective pixels 30 are detected using image processing or a machine learning model that is trained to map an image 22 acquired by an optical system 10, 10′ to locations 44 of effects of defective pixels in the image 30.
5. The method of any one of the preceding clauses, wherein effects of defective pixels 30 are detected from a calibration image acquired by the optical system 10, 10′ using a calibration object.
6. The method of any one of the preceding clauses, wherein effects of defective pixels 30 are reduced by reconstructing missing information from the image 22 using a regression function 40.
7. The method of clause 6, wherein the regression function 40 comprises a kernel-ridge regression function with a sinc-kernel.
8. The method of clause 6 or 7, wherein one or more hyperparameters of the regression function 40 are selected according to parameters of the optical system 10, 10′.
9. The method of any one of clauses 6 to 8, wherein one or more hyperparameters of the regression function 40 are optimized using images 22 of objects 14 comprising integrated circuit patterns and corresponding images with simulated effects of defective pixels 30.
10. The method of any one of clauses 6 to 9, wherein the regression function 40 is partially pre-computed using pre-defined locations 42 relative to the effects of defective pixels 30 in the image 22.
11. The method of any one of clauses 6 to 10, wherein the regression function 40 is a one-dimensional function that reconstructs pixel values from pixels along a line in the image 22.
12. The method of any one of clauses 6 to 10, wherein the regression function 40 is a two-dimensional function that uses different basis functions and/or different hyperparameters in each dimension of the image 22.
13. The method of any one of the preceding clauses, wherein effects of defective pixels 30 are reduced using an inpainting method.
14. The method of any one of the preceding clauses, wherein effects of defective pixels 30 are reduced using a machine learning model 46, the machine learning model 46 being trained to map an image 22 of an object 14 comprising integrated circuit patterns obtained by an optical system 10, 10′ to an image 22 with reduced effects of defective pixels 30.
15. The method of any one of the preceding clauses, wherein effects of defective pixels 30 are reduced by iteratively reconstructing the image 22 in the signal domain and in the spectral domain.
16. A method 84 for quality inspection of an object 14 comprising integrated circuit patterns, the method comprising:
   Providing an improved image of an object 14 comprising integrated circuit patterns using a method according to any one of the preceding clauses;
   Using the improved image 34 for quality inspection of the object 14 comprising integrated circuit patterns.
17. The method of clause 16, further comprising providing a reference image 24 of the object 14 comprising integrated circuit patterns and using the improved image and the reference image 24 for quality inspection of the object 14 comprising integrated circuit patterns.
18. The method of clause 17, wherein the provided reference image is improved using a method according to any one of clauses 1 to 15.
19. An optical system 90 for quality inspection of an object 14 comprising integrated circuit patterns, the optical system 90 comprising:
   one or more image sensors configured for acquiring an image 22 of an object 14 comprising integrated circuit patterns, wherein at least one image sensor comprises one or more defective pixels;
   one or more processing devices 92;
   one or more machine-readable hardware storage devices 94 comprising instructions that are executable by one or more processing devices 92 to perform operations comprising a method 84 for quality inspection of an object 14 comprising integrated circuit patterns according to any one of clauses 16 to 18.
20. The optical system 90 of clause 19, further comprising at least one embedded system 88 configured for reconstructing an image 22 of an object 14 comprising integrated circuit patterns according to any one of clauses 1 to 15.

In a general aspect, the invention relates to a computer-implemented method and optical system for quality inspection of an object comprising integrated circuit patterns using an optical system, the optical system comprising at least one image sensor having one or more defective pixels, the method comprising: providing one or more images of the object acquired by the optical system, wherein at least one of the images comprises effects of the one or more defective pixels; reconstructing pixel values in at least one of the images at locations affected by the defective pixels using a reconstruction method, wherein one or more parameters of the reconstruction method are selected based on at least one parameter of the optical system used to acquire the one or more images; and detecting one or more defects in the object and/or determining positions of structures in the object based on the at least one reconstructed image.

### REFERENCE NUMBER LIST

10, 10′ Optical metrology system
12 Light source
14 Object comprising integrated circuit patterns
16 Illumination optics
17 Projection optics
18 Wafer plane
19 Projection section
20 Image sensor
22 Image
24 Reference image
26 Difference image
28 False positive defect detection
30 Effect of defective pixel
32 Method
34 Reconstructed image
36 Support data points
38 True data point
40 Regression function
42 Pre-defined location
44 Location affected by a defective pixel
46 U-Net
48 Conv 3×3 batch norm operation
50 Max pool 2×2 operation
52 Up-conv 2×2 operation
54 Copy and concatenate operation
56 Skip connection
58 Input data
60 Output data
64 Image without effects of defective pixels
66 Image with effects of defective pixels
68 Papoulis-Gerchberg reconstruction
70 Linear regression reconstruction
72 Cubic regression reconstruction
73 Sinc regression reconstruction
74 NA filter
76 First difference image
78 Second difference image
80 Third difference image
82 Fourth difference image
83 Fifth difference image
84 Method
85 Defect
86 Reconstructed reference image
87 Structure
88 Embedded system
89 Corresponding structure
90 Optical system
92 Processing device
94 Machine-readable hardware storage device
96 Data analysis device
98 Interface
100 Camera

What is claimed is:

1. A computer-implemented method for quality inspection of an object comprising integrated circuit patterns using an optical system, the optical system comprising at least one image sensor having one or more defective pixels, the method comprising:
providing one or more images of the object acquired by the optical system, wherein at least one of the images comprises effects of the one or more defective pixels;
reconstructing pixel values in at least one of the images at locations affected by the defective pixels using a reconstruction method, wherein one or more parameters of the reconstruction method are selected based on at least one parameter of the optical system used to acquire the one or more images; and
detecting one or more defects in the object and/or determining positions of structures in the object based on the at least one reconstructed image.

2. The method of claim 1, wherein the reconstruction method comprises a regression function, and wherein one or more parameters of the regression function are selected based on at least one parameter of the optical system.

3. The method of claim 2, wherein the regression function comprises a kernel-ridge regression function using a sinc-kernel.

4. The method of claim 1, wherein the reconstruction method accounts for a spatial frequency limitation of the optical system resulting from a numerical aperture of the optical system.

5. The method of claim 1, wherein the reconstruction method comprises a kernel ridge regression function using a sinc kernel, wherein the sinc kernel is selected based on a spatial frequency limitation of the optical system defined by a numerical aperture of the optical system.

6. The method of claim 1, wherein the reconstruction method comprises applying a machine learning model, the machine learning model being configured to map at least one image affected by defective pixels to at least one image with reduced effects of defective pixels.

7. The method of claim 1, wherein reconstructing pixel values comprises iteratively reconstructing the at least one image in a signal domain and in a spectral domain.

8. The method of claim 1, wherein the at least one parameter of the optical system comprises at least one of a numerical aperture, a pixel size, an imaging wavelength, or a parameter related to an expected noise level of the at least one image sensor or the one or more acquired images.

9. The method of claim 1, wherein the reconstruction method is a one-dimensional function that reconstructs pixel values from pixels along a line in the one or more images.

10. The method of claim 1, wherein the reconstruction method is a two-dimensional function that uses different basis functions and/or different hyperparameters in each dimension of the one or more images.

11. The method of claim 1, wherein the reconstruction method reconstructs pixel values using pixel values at predefined relative locations with respect to each location affected by a defective pixel.

12. The method of claim 1, wherein a reconstructed image is obtained by combining two or more images of the object, wherein at least one of the images includes reconstructed pixel values.

13. The method of claim 12, wherein at least one of the images does not contain effects of defective pixels.

14. The method of claim 1, wherein effects of defective pixels are detected using image processing or a machine learning model that is configured to map one or more images acquired by an optical system to locations of effects of defective pixels in the one or more images.

15. The method of claim 1, wherein effects of defective pixels are detected from one or more calibration images acquired by the optical system using a calibration object.

16. The method of claim 1, wherein reconstructing pixel values is performed by an embedded system of the optical system.

17. The method of claim 1, wherein one or more parameters of the reconstruction method are optimized using images of objects comprising integrated circuit patterns and corresponding images with simulated effects of defective pixels.

18. The method of claim 1, wherein reconstructing pixel values comprises weighting pixel values used for reconstruction based on a distance from a location affected by a defective pixel and/or based on a confidence measure associated with the pixel values.

19. The method of claim 1, wherein reconstructing pixel values comprises selecting pixel values along one or more directions corresponding to structures in the object.

20. The method of claim 1, wherein reconstructing pixel values is performed locally using pixel values within a neighborhood of each location affected by a defective pixel, wherein the neighborhood is selected based on at least one parameter of the optical system.

21. The method of claim 1, wherein the at least one parameter of the optical system comprises a parameter related to an expected noise level, and wherein the reconstruction method is configured to adjust at least one of a regularization parameter, kernel parameter, or weighting factor based on the expected noise level.

22. The method of claim 1, wherein detecting the one or more defects comprises: providing at least one reference image of the object; registering the at least one reconstructed image with the at least one reference image; and detecting the one or more defects in the object based on a deviation between the registered images.

23. The method of claim 1, wherein determining positions of structures in the object comprises determining positional deviations of structures in the object.

24. The method of claim 1, further comprising controlling at least one manufacturing process parameter of a manufacturing process for the object based on the detected one or more defects and/or the determined positions of structures.

25. The method of claim 1, further comprising modifying the object comprising integrated circuit patterns using a repair apparatus based on the detected one or more defects and/or the determined positions of structures, wherein modifying comprises at least one of: depositing material, removing material, or locally modifying a material property of the object.

26. An optical system for quality inspection of an object comprising integrated circuit patterns, the optical system comprising:
at least one image sensor having one or more defective pixels;
one or more processing devices;
one or more machine-readable hardware storage devices comprising instructions that are executable by one or more processing devices to perform operations comprising a method for quality inspection of an object comprising integrated circuit patterns according to claim 1.

27. The optical system of claim 26, further comprising at least one embedded system configured to reconstruct pixel values at locations affected by defective pixels using a reconstruction method as defined in claim 1.
